(19) United States
(12) Patent Application Publication
(10) Pub. No.: US 2015/0186056 A1
(43) Pub. Date: Jul. 2, 2015

(54) STORAGE DEVICE SYSTEM

(71) Applicants: Seiji Miura, Tokyo (JP); Hiroshi Uchigaito, Tokyo (JP); Kenzo Kurotsuchi, Tokyo (JP)

(72) Inventors: Seiji Miura, Tokyo (JP); Hiroshi Uchigaito, Tokyo (JP); Kenzo Kurotsuchi, Tokyo (JP)

(73) Assignee: HITACHI, LTD.

(21) Appl. No.: 14/423,384

(22) PCT Filed: Sep. 7, 2012
(86) PCT No.: PCT/JP2012/072961

§ 371 Date: Feb. 23, 2015

(51) Int. Cl. G06F 3/06

(52) U.S. Cl. CPC G06F 3/0616; G06F 3/0652; G06F 3/0653; G06F 3/0659; G06F 3/0688

(57) ABSTRACT

In a storage device system having a plurality of memory modules including a non-volatile memory, improved reliability and a longer life or the like is to be realized. To this end, a plurality of memory modules (STG) notifies a control circuit DKCTL0 of a write data volume (Wstg) that is actually written in an internal non-volatile memory thereof. The control circuit DKCTL0 finds a predicted write data volume (eWd) for each memory module on the basis of the write data volume (Wstg), a write data volume (Wh2d) involved in a write command that is already issued to the plurality of memory modules, and a write data volume (ntW) involved in a next write command. Then, a next write command is issued to the memory module having the smallest predicted write data volume.

### TECHNICAL FIELD

The present invention relates to a storage device system, for example, a control technique for external storage device (storage) such as an SSD (Solid State Drive).

### BACKGROUND ART

In recent years, an SSD (Solid State Drive) composed of a plurality of NAND-type flash memories and a controller is used for a storage system, server device and laptop PC or the like. It is widely known that there is an upper limit to the number of erasures of a NAND-type flash memory and that the data writing size and the data erasing size thereof differ significantly.

PTL 1 discloses a technique for realizing hierarchical capacity virtualization and reducing a disparity in the number of erasures across an entire storage system. Specifically, a technique for carrying out so-called static wear leveling in which the number of erasures is leveled by property moving, as a target, data that is already written, is disclosed. Also, PTL 2 discloses a management method for a storage system using a flash memory. PTL 3 discloses a control technique for the time of power cutoff in a storage system. PTL 4 discloses a control technique for an SSD. PTL 5 discloses a data transfer technique between an HDD and an SSD.

### CITATION LIST

### Patent Literature

PTL 1: International Publication 2011/010344

PTL 2: JP-A-2011-3111

PTL 3: JP-A-2011-138273

PTL 4: JP-A-2011-90496

PTL 5: JP-A-2007-115232

### SUMMARY OF INVENTION

### Technical Problem

Prior to the present application, the present inventors have studied control methods for a NAND-type flash memory used for a storage such as an SSD (Solid State Drive) or memory card.

In a non-volatile memory represented by a NAND-type flash memory, in order to write data in a certain memory area, the data in the memory area needs to be erased in advance. The minimum data unit at the time of this erasure is, for example, 1 Mbyte or the like, and the minimum data unit at the time of writing is, for example, 4 Kbytes or the like. In other words, in order to write data of 4 Kbytes, an erased memory area of 1 Mbyte needs to be secured. In order to secure this erased memory area of 1 Mbyte, an operation called garbage collection is necessary within the SSD.

In this garbage collection operation, first, the currently valid data are read out from non-volatile memory areas A and B of 1 Mbyte in which data is already written, and these data are collected and written in a RAM. Then, the data in the non-volatile memory areas A and B are erased. Finally, the data written in the RAM are collectively written in the non-volatile memory area A. By this garbage collection operation, the non-volatile memory area B of 1 Mbyte becomes an erased memory area and new data can be written in this non-volatile memory area B.

However, by this garbage collection operation, a movement of data from one non-volatile memory area to another non-volatile memory area occurs in the SSD. In this case, writing with a larger data size than the write data size requested of the SSD by the host controller is performed. Therefore, there is a risk that the reliability and life of the SSD may be reduced. Moreover, if, for example, a storage system is constructed using multiple SSDs using a NAND-type flash memory, a storage controller for controlling the multiple SSDs cannot grasp the actual write data volume including write data volumes increased by the garbage collection operation and wear leveling or the like that each SSD autonomously performs internally. Therefore, there is a risk that the reliability and life as the storage system (storage device system) may be reduced.

The invention has been made in view of the foregoing, and the above and other objects and novel features of the invention will become clear from the description of this specification and the accompanying drawings.

### Solution to Problem

The outline of a representative embodiment of the inventions disclosed in the present application will be briefly described as follows.

A storage device system according to this embodiment includes a plurality of memory modules and a first control circuit for controlling the plurality of memory modules. Each memory module of the plurality of memory modules has a plurality of non-volatile memories and a second control circuit for controlling the non-volatile memories. The second control circuit grasps a second write data volume with which writing is actually performed to the plurality of non-volatile memories, and properly notifies the first control circuit of the second write data volume. The first control circuit grasps a first write data volume involved in a write command that is already issued to the plurality of memory modules, for each memory module of the plurality of memory modules, and calculates a first ratio that is a ratio of the first write data volume to the second write data volume, for each memory module of the plurality of memory modules. Then, the first control circuit selects a memory module to which a next write command is to be issued, from among the plurality of memory modules, reflecting a result of the calculation.

### Advantageous Effect of Invention

To briefly describe advantageous effects achieved by the representative embodiment of the inventions disclosed in the present application, improved reliability and a longer life or the like can be realized in a storage device system having a plurality of memory modules including a non-volatile memory.

### BRIEF DESCRIPTION OF DRAWINGS

FIG. 1 is a block diagram showing a schematic configuration example of an information processing system using a storage device system according to Embodiment 1 of the invention.

FIG. 2 is a block diagram showing a detailed configuration example of a storage controller of FIG. 1.

FIG. 3 is a flowchart showing an example of a write operation carried out by a storage module control circuit of FIGS. 1 and 2.

FIG. 4A is a supplementary diagram of FIG. 3, showing an example of a content held in a table (MGTBL) held in the storage module control circuit.

FIG. 4B is a supplementary diagram of FIG. 3, showing an example of another content held in the table (MGTBL) held in the storage module control circuit.

FIG. 5A is a diagram showing an example of a content held in a table (STGTBL) held in the storage module control circuit of FIG. 2.

FIG. 5B is a diagram showing an example of another content held in the table (STGTBL) held in the storage module control circuit of FIG. 2.

FIG. 5C is a diagram showing an example of still another content held in the table (STGTBL) held in the storage module control circuit of FIG. 2.

FIG. 5D is a diagram showing an example of still another content held in the table (STGTBL) held in the storage module control circuit of FIG. 2.

FIG. 6 is a block diagram showing a detailed configuration example of a storage controller of FIG. 1.

FIG. 7 is a flowchart showing an example of a wear leveling method carried out in the storage module of FIG. 1.

FIG. 8 is a flowchart showing an example of a garbage collection and wear leveling method carried out in the storage module of FIG. 1.

FIG. 9 is a flowchart showing a read operation example carried out by the storage module control circuit and a storage control circuit of FIG. 1.

FIG. 10 is a flowchart showing an example of a write operation carried out by the storage module control circuit of FIGS. 1 and 2, in a storage device system according to Embodiment 2 of the invention.

FIG. 11A is a supplementary diagram of FIG. 10, showing an example of a content held in a table (MGTBL) held in the storage module control circuit.

FIG. 11B is a supplementary diagram of FIG. 10, showing an example of another content held in the table (MGTBL) held in the storage module control circuit.

FIG. 12 is a flowchart showing example of a write operation and a garbage collection management operation carried out by the storage module control circuit of FIGS. 1 and 2, in a storage device system according to Embodiment 3 of the invention.

FIG. 13A is a supplementary diagram of FIG. 12, showing an example of a content held in a table (MGTBL) held in the storage module control circuit of FIG. 2.

FIG. 13B is a supplementary diagram of FIG. 12, showing an example of another content held in the table (MGTBL) held in the storage module control circuit of FIG. 2.

FIG. 13C is a supplementary diagram of FIG. 12, showing an example of still another content held in the table (MGTBL) held in the storage module control circuit of FIG. 2.

FIG. 14A is a supplementary diagram of FIG. 12, showing an example of a content held in a table (GETBL) held in the storage module control circuit of FIG. 2.

FIG. 14B is a supplementary diagram of FIG. 12, showing an example of another content held in the table (GETBL) held in the storage module control circuit of FIG. 2.

FIG. 14C is a supplementary diagram of FIG. 12, showing an example of still another content held in the table (GETBL) held in the storage module control circuit of FIG. 2.

FIG. 15 is a flowchart showing an example of a write operation and an erase operation carried out by the storage module control circuit of FIGS. 1 and 2, in a storage device system according to Embodiment 4 of the invention.

FIG. 16A is a supplementary diagram of FIG. 15, showing an example of a content held in a table (MGTBL) held in the storage module control circuit of FIG. 2.

FIG. 16B is a supplementary diagram of FIG. 15, showing an example of another content held in the table (MGTBL) held in the storage module control circuit of FIG. 2.

FIG. 16C is a supplementary diagram of FIG. 15, showing an example of still another content held in the table (MGTBL) held in the storage module control circuit of FIG. 2.

FIG. 17 is a flowchart showing an example of a write operation and a garbage collection management operation carried out by the storage module control circuit of FIGS. 1 and 2, in a storage device system according to Embodiment 5 of the invention.

FIG. 18A is a supplementary diagram of FIG. 17, showing an example of a content held in a table (MGTBL) held in the storage module control circuit of FIG. 2.

FIG. 18B is a supplementary diagram of FIG. 17, showing an example of another content held in the table (MGTBL) held in the storage module control circuit of FIG. 2.

FIG. 18C is a supplementary diagram of FIG. 17, showing an example of still another content held in the table (MGTBL) held in the storage module control circuit of FIG. 2.

FIG. 19 is an explanatory diagram showing an example of a read operation carried out by the storage module control circuit of FIGS. 1 and 2, in the storage device system according to Embodiment 5 of the invention.

FIG. 20A is an explanatory diagram showing an example of data holding characteristics of the storage module, in the storage device system according to Embodiment 2 of the invention.

FIG. 20B is a diagram showing an example in which the data holding characteristics of FIG. 20A are prescribed in a table.

FIG. 21 is a block diagram showing a detailed configuration example of the storage module of FIG. 1, in a storage device system according to Embodiment 6 of the invention.

FIG. 22 is a supplementary diagram for roughly explaining the flow of FIG. 7

FIG. 23 is a supplementary diagram for roughly explaining the flow of FIG. 8.

### DESCRIPTION OF EMBODIMENTS

In the embodiments below, the explanation is divided into multiple sections or embodiments, when necessary as a matter of convenience. These are not unrelated to each other and are in such a relation that one is a modification example, application example, detailed explanation, supplementary explanation or the like of a part or all of another, unless particularly stated otherwise. Also, in the embodiments below, when a number or the like about an element (including the number of units, numeric value, amount, range or the like) is mentioned, the specific number is not limiting, and a number equal to or greater than the specific number, or a number equal to or smaller than the specific number may also be employed, unless particularly stated otherwise or unless the specific number is clearly limiting in theory.

Moreover, in the embodiments below, components thereof (including component steps or the like) are not necessarily essential unless particularly stated otherwise or unless these are clearly essential in theory. Similarly, in the embodiments below, when the shape, positional relation or the like of a component is mentioned, it includes a shape that is substantially approximate or similar to that shape, or the like, unless particularly state otherwise or unless considered clearly otherwise in theory. This also applies to the foregoing number or the like (including the number of units, numeric value, amount, range or the like).

Hereinafter, the embodiments of the invention will be described in detail on the basis of the drawings. Throughout the drawings for explaining the embodiments, members having the same function are denoted by the same or associated reference number and repetition of the explanation thereof is omitted. Also, in the embodiments below, the explanation of the same or similar part is not repeated in principle unless particularly necessary.

### Embodiment 1

### Outline of Information Processing System

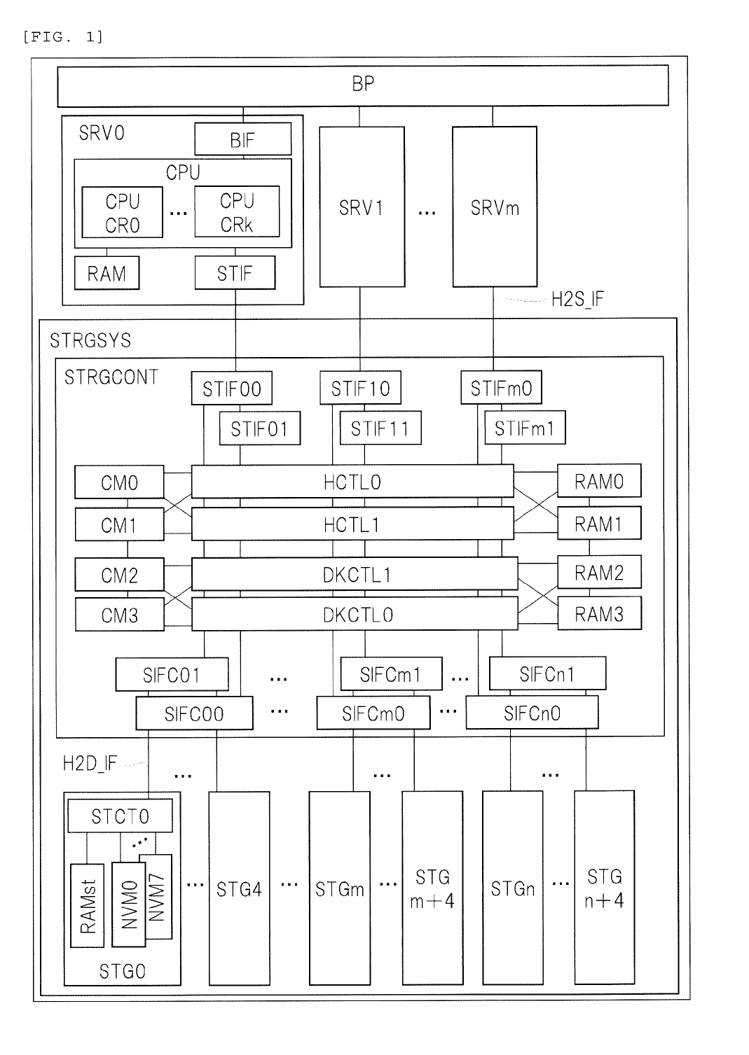

FIG. 1 is a block diagram showing a schematic configuration example of an information processing system using the storage device system according to Embodiment 1 of the invention. The information processing system shown in FIG. 1 includes information processing devices SRV0 to SRVm, and a storage system (storage device system) STRGSYS. STRGSYS includes a plurality of storage modules (memory modules) STG0 to STGn+4, and a storage controller STRGCONT which controls STG0 to STGn+4 according to a request from SRV0 to SRVm. The information processing devices SRV0 to SRVm and the storage controller STRGCONT are connected together via an interface signal H2S_IF. The storage controller STRGCONT and the storage modules STG0 to STGn+4 are connected together via an interface signal H2D_IF.

As the communication system of the interface signals H2S_IF and H2D_IF, for example, a serial interface signal system, parallel interface signal system, optical interface signal system or the like can be used. Typical interface signal systems may be SCSI (Small Computer System Interface), SATA (Serial Advanced Technology Attachment), SAS (Serial Attached SCSI), FC (Fibre Channel) or the like. As a matter of course, all the systems can be used.

The information processing devices SRV0 to SRVm are, for example, server devices or the like and devices that execute various applications on various OS. Each of SRV0 to SRVm has a processor unit CPU having a plurality of processor cores CPUCR0 to CPUCRk, a random access memory RAM, a pack plane interface circuit BIF, and storage system interface circuit STIF. BIF is a circuit for communication between the respective SRV0 to SRVm via a back plane BP. STIF is a circuit for making various requests (write request (WQ), read request (RQ) or the like) using the interface signal H2S_IF, to the storage system (storage device system) STRGSYS.

In the storage modules (memory modules) STG0 to STGn+4, data, applications and OS or the like that are necessary in the information processing devices SRV0 to SRVm are stored. STG0 to STGn+4 are equivalent to, for example, SSDs (Solid State Drives) or the like, though not particularly limiting. STG0 to STGn+4 each have a similar configuration. To explain STG0 as a representative, for example, STG0 has non-volatile memories NVM0 to NVM7, a random access memory RAMst, and a storage control circuit STCT0 which controls accesses or the like to these. As NVM0 to NVM7, for example, NAND-type flash memories, NOR-type flash memories, phase-change memories, resistance-change memories, magnetic memories, ferroelectric memories or the like can be used.

The information processing devices SRV0 to SRVm issue a read request (RQ) of a necessary program or data to the storage controller STRGCONT, for example, when executing an application. Also, SRV0 to SRVm issue a write request (write command) (WQ) to store their own execution results and data, to the storage controller STRGCONT. A logical address (LAD), data read command (RD), sector count (SEC) or the like are included in the read request (RQ). A logical address (LAD), data write command (WRT), sector count (SEC), and write data (WDATA) or the like are included in the write request (WQ).

The storage controller STRGCONT has internal memories including cache memories CM0 to CM3 and random access memories RAM0 to RAM3, host control circuits HCTL0, HCTL1, and storage module control circuits DKCTL0, DKCTL1. In addition, STRGCONT has storage system interface circuits STIF (00, 01, . . . , m0, m1) and storage module interface circuits SIFC (00, 01, . . . , n0, n1).

The host control circuits HCTL0, HCTL1 are circuits that mainly control communication with the information processing devices SRV0 to SRVm (for example, reception of various requests from SRV0 to SRVm (read request (RQ) and write request (WQ) and the like) and response to SRV0 to SRVm, and the like). In this communication between HCTL0, HTCL1 and SRV0 to SRVm, the interface circuits STIF perform protocol conversion according to the communication system of the interface signal H2S_IF. The storage module control circuits DKCTL0, DKCTL1 are circuits that mainly perform communication of an access request or the like to the storage modules STG0 to STGn+4 in response to various requests from SRV0 to SRVm received by HCTL0, HCTL1. In this communication of an access request or the like, the interface circuits SIFC perform protocol conversion according to the communication system of the interface signal H2D_IF.

Although not particularly limiting, the host control circuits HCTL0, HCTL1 are provided as two systems, and one (for example, HCTL1) is provided as a spare in the case of failure in the other (for example, HCTL0). The storage module control circuits DKCTL0, DKCTL1, the interface circuits STIF (for example, STIF00 and STIF01), and the interface circuits SIFC (for example, SIFC00 and SIFC01), too, are similarly provided in such a way that one is a spare for the other, in order to improve fault tolerance. Here, though not particularly limiting, a configuration in which five storage modules (memory modules) (here, STG0 to STG4) are connected to one SIFC (for example, SIFC00) is provided. This number can be properly decided in consideration of the specifications or the like of RAID (Redundant Arrays of Inexpensive Disks) (for example, data is written divisionally in four STG and the parities thereof are written in the remaining one, or the like).

Next, the overall operation of the information processing system of FIG. 1 will be briefly described. The host control circuits HCTL0, HCTL1 receive a read request (RQ) and a write request (write command) (WQ) or the like from the information processing devices SRV0 to SRVm via the storage system interface circuits STIF (00, 01, . . . , m0, m1). For example, when a read request (RQ) is received, HCTL0, HCTL1 first check whether data (RDATA) of the logical address (LAD) included in the read request (RQ) is stored in the internally provided cache memories CM0 to CM3.

Here, if the data (RDATA) is stored in the cache memories CM0 to CM3, that is, in the case of a hit, the host control circuits HCTL0, HCTL1 read out the data (RDATA) from CM0 to CM3 and transfer the data to the information processing devices SRV0 to SRVm via the interface circuits STIF (interface signal H2S_IF). Meanwhile, if the data (RDATA) is not stored in CM0 to CM3, that is, in the case of a mishit, HCTL0, HCTL1 notify the storage module control circuits DKCTL0, DKCTL1. In response to this, DKCTL0, DKCTL1 issue a read access request (RREQ) to the storage modules (memory modules) STG0 to STGn+4 via the interface circuits SIFC (00, 01, . . . , n0, n1) (interface signal H2D_IF). Subsequently, DKCTL0, DKCTL1 transfer the data (RDATA) read out from STG0 to STGn+4, to CM0 to CM3, and also transfer the data to SRV0 to SRVm via HCTL0, HCTL1 and STIF (H2S_IF).

Also, when a write request (WQ) from the information processing devices SRV0 to SRVm is received, the host control circuits HCTL0, HCTL1 first determine whether the logical address (LAD) included in the write request (WQ) coincides with one of the logical addresses (LAD) entered in the cache memories CM0 to CM3. Here, in the case of a coincidence, that is, in the case of a hit, HCTL0, HCTL1 write the write data (WDATA) included in the write request (WQ), in CM0 to CM3. Meanwhile, in the case of no coincidence, that is, in the case of a mishit, HCTL0, HCTL1 transfer, for example, write data (WDT) with respect to the oldest logical address (LAD) to be used in CM0 to CM3, temporarily to the random access memories RAM0 to RAM3, and then write the write data (WDATA) in CM0 to CM3. Subsequently, a notification is given from HCTL0, HCTL1 to DKCTL0, DKCTL1. In response to this, DKCTL0, DKCTL1 issue a write access request (write command) (WREQ) to the storage modules (memory modules) STG0 to STGn+4. That is, with the write access request (WREQ), the write data (WDT) transferred to RAM0 to RAM3 is written in (written back to) STG0 to STGn+4 via the interface circuits SIFC (00, 01, . . . , nO, n1) (interface signal H2D_IF).

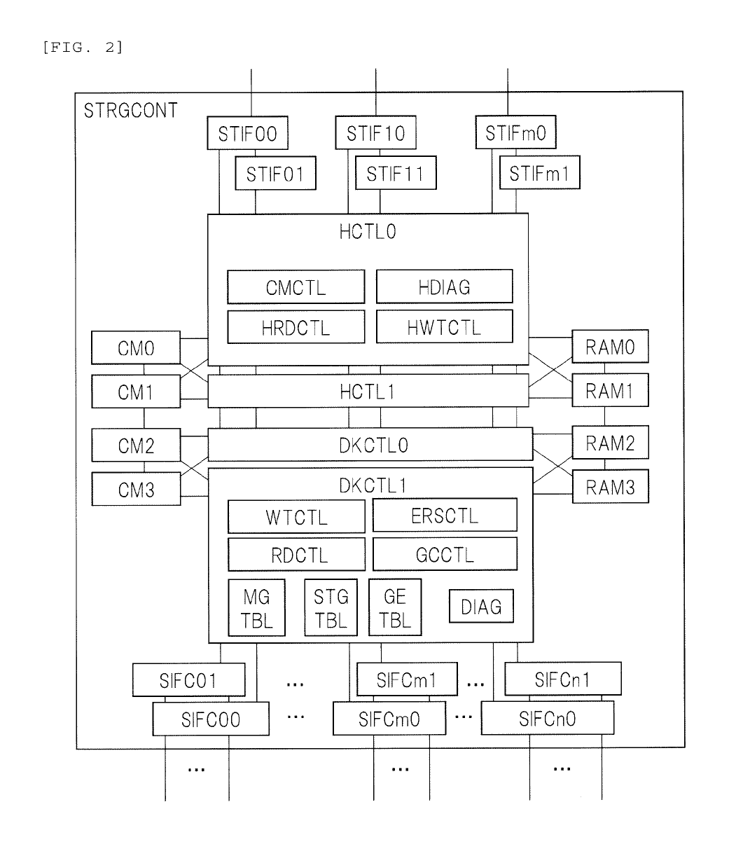

FIG. 2 is a block diagram showing a detailed configuration example of the storage controller STRGCONT of FIG. 1. In the storage controller STRGCONT shown in FIG. 2, a detailed configuration example relating to the host control circuits HCTL0, HCTL1 and the storage module control circuits DKCTL0, DKCTL1 shown in FIG. 1 is illustrated. Each of HCTL0, HCTL1 has a cache control circuit CMCTL, a read control circuit HRDCTL, a write control circuit HWTCTL, and a diagnostic circuit HDIAG.

The cache control circuit CMCTL performs determination on hit or mishit in the cache memories CM0 to CM3, access control of CM0 to CM3 and the like. The read control circuit HRDCTL performs, with CMCTL, various kinds of processing involved in a read request (RQ) as described with reference to FIG. 1, when a read request (RQ) from the information processing devices (hosts) SRV0 to SRVm is received. The write control circuit HWTCTL performs, with CMCTL, various kinds of processing involved in a write request (WQ) as described with reference to FIG. 1, when a write request (WQ) from SRV0 to SRVm is received. The diagnostic circuit HDIAG has the function of testing whether various functions of its own are normal or not, for the improvement in fault tolerance described with reference to FIG. 1. For example, when an abnormality is detected by HDIAG in the control circuit HCTL0, this HDIAG notifies the control circuit HCTL1. With this, HCTL0 for regular use is inactivated and HCTL1 as a spare is activated instead.

Each of the control circuits DKCTL0, DKCTL1 has a write control circuit WTCTL, a read control circuit RDCTL, a data erasure control circuit ERSCTL, a garbage collection control circuit GCCTL, a diagnostic circuit DIAG, and three tables MGTBL, STGTBL, GETBL. DIAG has the function of testing its own internal functions, as in the case of the diagnostic circuits HDIAG in HCTL0, HCTL1, and activation and inactivation of DKCTL0 and DKCTL1 are switched according to the result thereof. The various tables MGTBL, STGTBL, GETBL have, as the substance thereof, the stored information in the random access memories RAM0 to RAM3, for example. The control circuits DKCTL0, DKCTL1 perform management of these various tables.

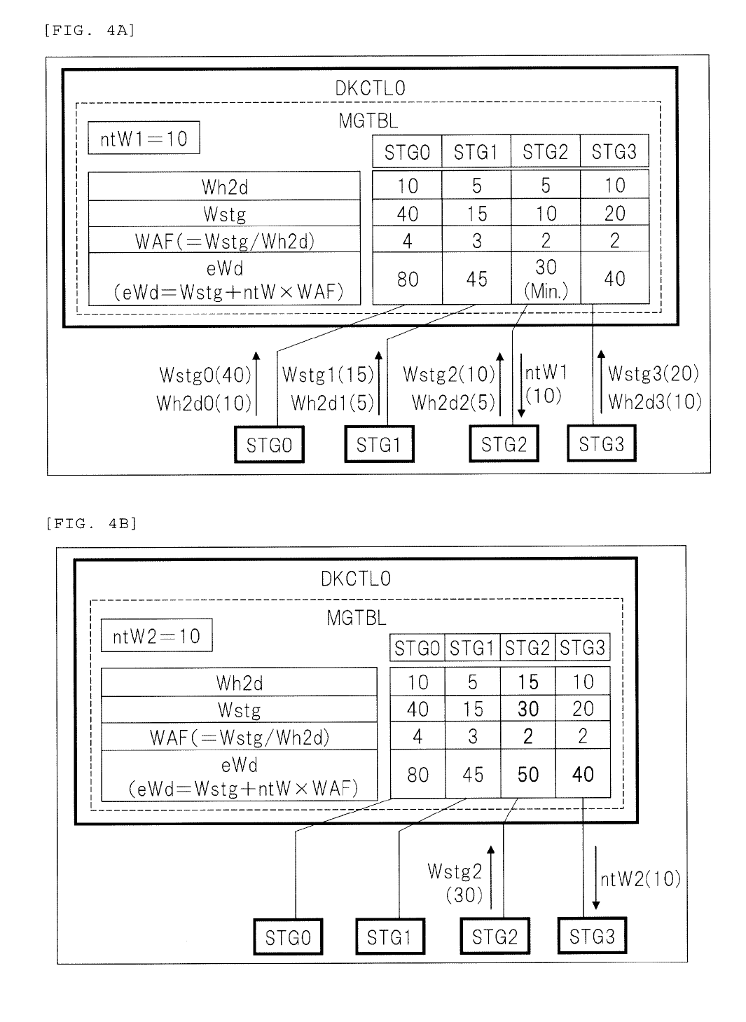

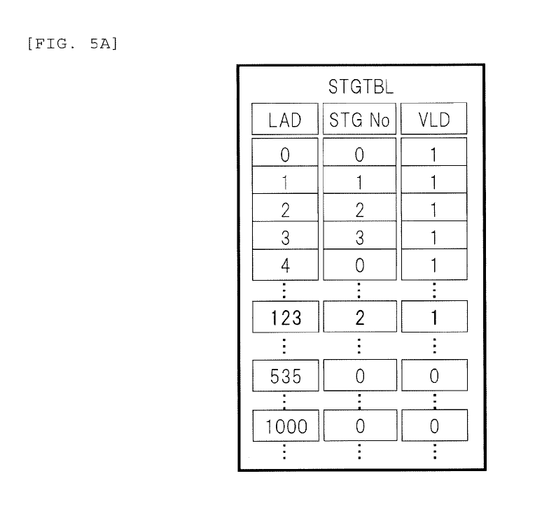

In the table MGTBL, as described in detail below according to need with reference to FIG. 4 and other drawings, various kinds of information (Wstg, Wh2d, ntW, WAF, eWd, Ret, Esz, and the like) for each storage module (memory module) are managed. Wstg represents the data size with which writing is actually performed by each of the storage modules (memory modules) STG0 to STGn+4 to its own non-volatile memories NVM0 to NVM7. Wh2d represents the data size with which a write access request (write command) (WREQ) is already issued to each of the storage modules STG0 to STGn+4 by the control circuits DKCTL0, DKCTL1. That is, the data size Wh2d is equal to the size of write data (WDT) transferred to the random access memories RAM0 to RAM3 at the time of a mishit in the cache memories CM to CM3, as described above, and consequently equal to the size of write data (WDATA) included in a write request (WQ) from the information processing devices SRV0 to SRVm.

ntW indicates the data size of write data (WDT) included in next write access request (write command) (WREQ). WAF represents the write data size ratio of the data size (Wh2d) to the data size (Wstg) (=Wstg/Wh2d). eWd represents the predicted write data size (=Wstg+ntW×WAF). Ret represents the data retention time in each of the storage modules STG0 to STGn+4. Esz represents the number of physical blocks in an erased state included in each of the storage modules STG0 to STGn+4.

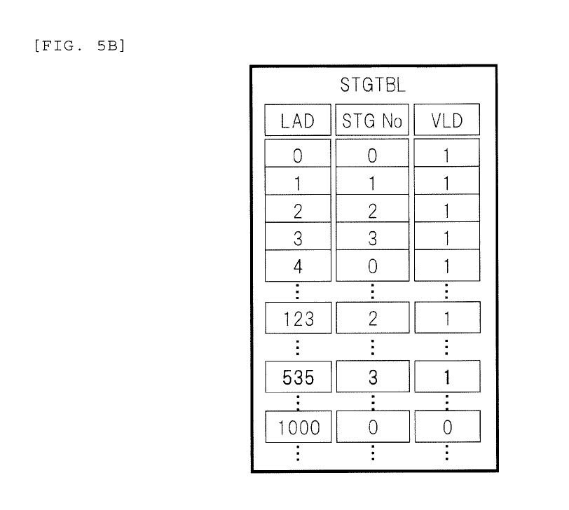

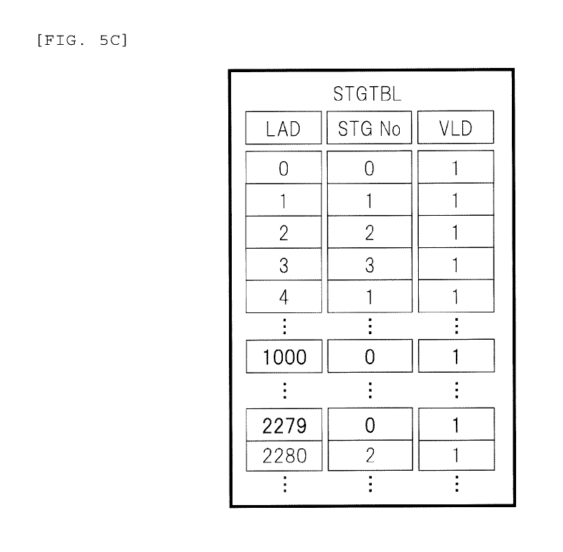

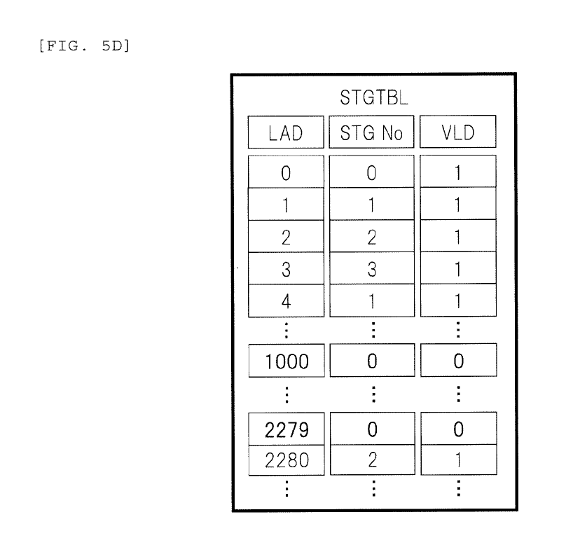

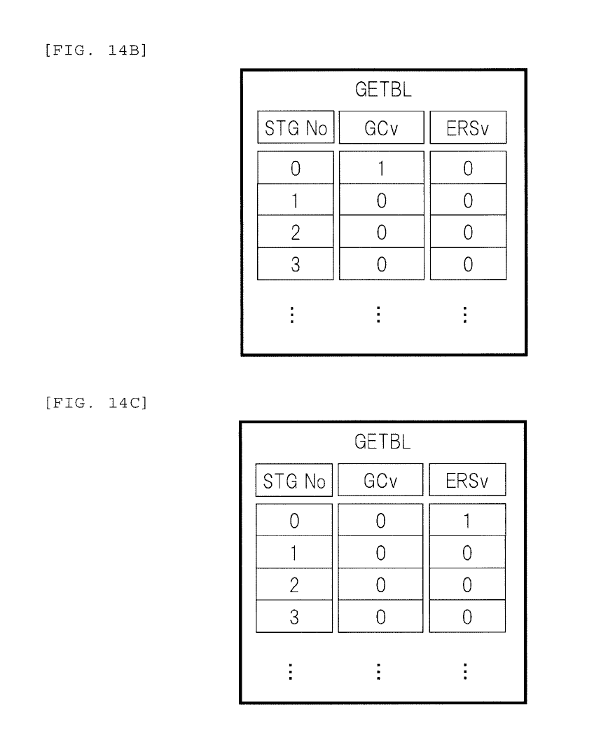

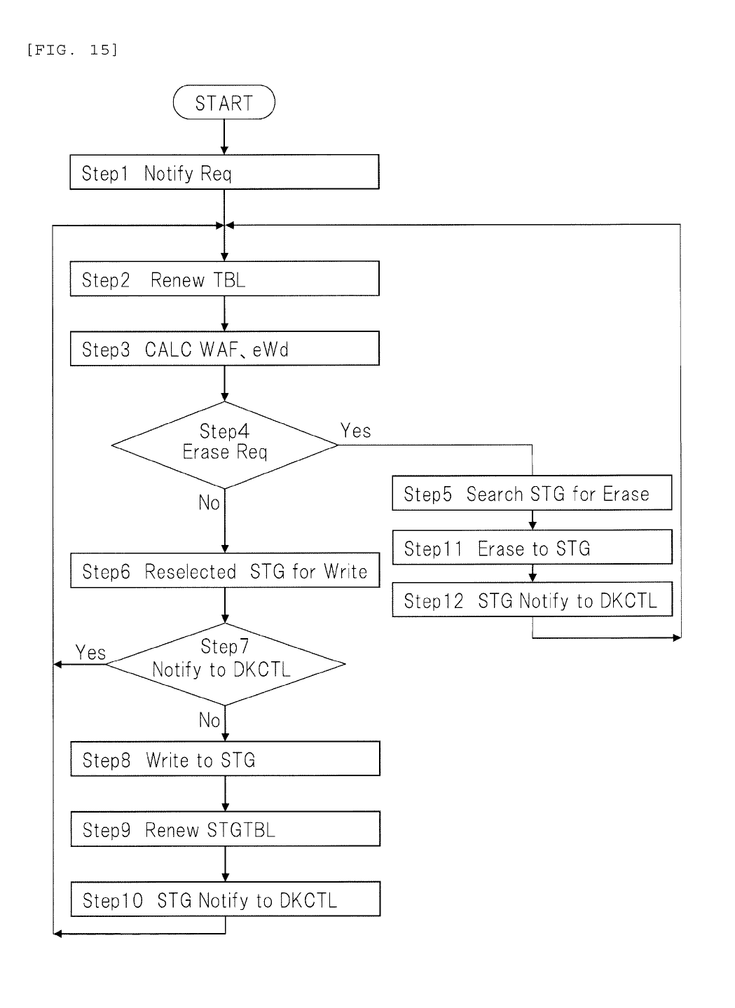

In the table STGTBL, as described in detail with reference to FIG. 5 and the like, which number in the storage modules (memory modules) STG0 to STGn+4 the logical address (LAD) is allocated to is managed. In the table GETBL, as described in detail with reference to FIG. 14 and the like, the status on whether each of the storage modules STG0 to STGn+4 is in a garbage collection operation or in a data erasure operation is managed. Also, as described in detail below, the write control circuit WTCTL issues a write access request (write command) (WREQ) to STG0 to STGn+4, properly using these respective tables. Similarly, using the respective tables, the read control circuit RDCTL issues a read access request (RREQ), the data erasure control circuit ERSCTL issues an erasure access request, and the garbage collection control circuit GCCTL issues a garbage collection request.

In the configurations as shown in FIGS. 1 and 2, there is a limit to the number of rewrites in the non-volatile memories NVM0 to NVM7 used in each of the storage modules (memory modules) STG0 to STGn+4. If writing is concentrated at a specific address in a specific non-volatile memory, the life of STG0 to STGn+4 is shortened. Meanwhile, in each of the storage modules STG0 to STGn+4, the storage control circuit STCT manages the number of writes in NVM0 to NVM7 on a certain data size basis, and performs writing in NVM0 to NVM7 in such a way as to level the number of writes. For example, in order to level the number of writes, there is a case where data is moved from one non-volatile memory to another non-volatile memory by the control circuit STCT, using a method called static wear leveling, as described in PTL 1 and the like. In this case, a larger size than the size of write data (WDT) requested by the control circuits DKCTL0, DKCTL1 is written in the non-volatile memory.

Also, in a non-volatile memory represented by a NAND-type flash memory, in order to write data in a certain memory area, the data in the memory area needs to be erased in advance. The minimum data unit at the time of this erasure is 1 Mbyte, for example, and the minimum data unit at the time of writing is 4 Kbytes, for example. That is, in order to write data of 4 Kbytes, an erased memory area of 1 Mbyte needs to be secured. In order to secure this erased memory area of 1 Mbyte, the control circuit STCT may carry out a garbage collection operation in some cases. At the time of this garbage collection operation, STCT first reads out the currently valid data from non-volatile memory areas “A” and “B” of 1 Mbyte in which data is already written, and collects and writes these data in the random access memory RAMst. Then, the data in the non-volatile memory areas A and B are erased. Finally, the data written in RAMst are collectively written in the non-volatile memory area “A”. By this, the non-volatile memory area “B” of 1 Mbyte becomes an erased memory area and new data can be written in this non-volatile memory area “B”. However, in this case, since a movement of data from one non-volatile memory area to another non-volatile memory area occurs, a larger data size than the size of the write data (WDT) requested by the control circuits DKCTL0, DKCTL1 is written in the non-volatile memory.

Moreover, in each of the storage modules STG0 to STGn+4, as represented by RAID or the like, along with the write data (WDT) requested by the control circuits DKCTL0, DKCTL1, an error detection and correction code such as parity data generated for the write data may be written in some cases. Again, in such cases, a larger size than the size of the write data (WDT) requested by the control circuits DKCTL0, DKCTL1 is written in the non-volatile memories in STG0 to STGn+4.

In this way, in each of the storage modules (memory modules) STG0 to STGn+4, the data size Wstg with which writing is actually performed to the non-volatile memories NVM0 to NVM7 can be larger than the size of the write data (WDT) requested of STG0 to STGn+4 by the control circuits DKCTL0, DKCTL1 (that is, the data size Wh2d). In this case, to what extent the actually written data size Wstg increases compared with the data size Wh2d involved in the write access request (write command) (WREQ) changes, for example, according to the locality or the like of the address involved in the write request (WQ) (write access request (WREQ)). Here, since this address is properly allocated to one of STG0 to STGn+4, to what extent the data size Wstg increases compared with this data size Wh2d may differ significantly among STG0 to STGn+4 in some cases.

Thus, as described in detail below, the storage controller STRGCONT has the function of predicting the write data volume with which writing is actually performed on the basis of the write data volume in the write access request (WREQ) which is the current processing target, selecting a storage module in which this predicted write data volume is small, and issuing this write access request (WREQ) there. In other words, the function of dynamic wear leveling among the storage modules is provided. Thus, not only the number of rewrites is leveled in each storage module but also the number of rewrites is leveled among the respective storage modules, and improvement in longevity is achieved in the storage modules (memory modules) STG0 to STGn+4 of FIG. 1 as a whole. Dynamic wear leveling is a method in which leveling is performed by properly selecting a writing destination at the time of writing data, unlike so-called static wear leveling in which leveling (wear leveling) is performed by properly moving data that is already written.

### Wear Leveling Among Storage Modules

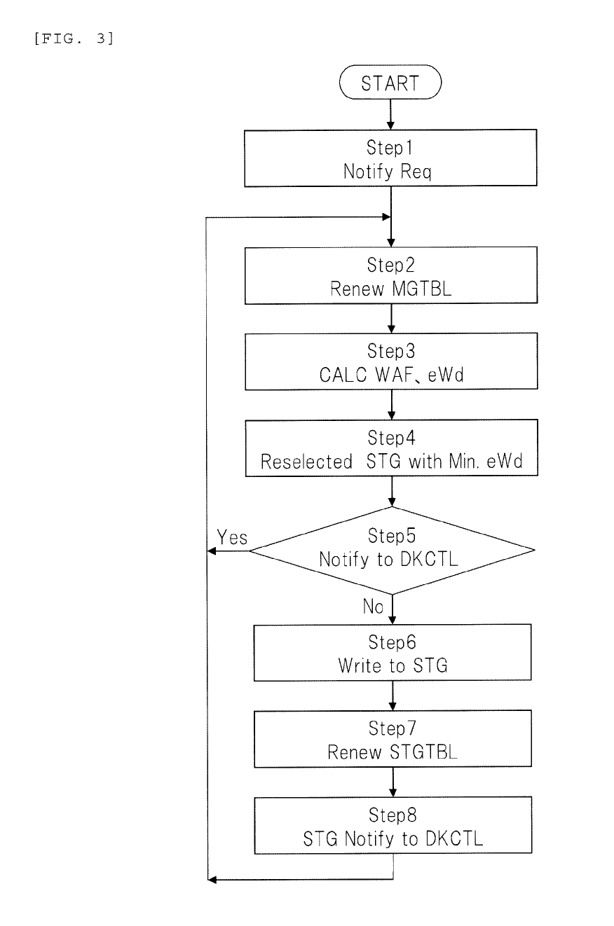

Hereinafter, to facilitate understanding of the explanation, the write operation performed by the storage module control circuit DKCTL0 will be described with reference to FIGS. 3 to 5, taking the case where four storage modules (memory modules) STG0 to STG3 are provided in FIG. 1, as an example. FIG. 3 is a flowchart showing an example of the write operation performed by the storage module control circuit of FIGS. 1 and 2. FIGS. 4A and 4B are supplementary diagrams of FIG. 3, showing an example of the content held in a table (MGTBL) held in the storage module control circuit. FIGS. 5A, 5B, 5C and 5D are diagrams showing an example of the content held in a table (STGTBL) held in the storage module control circuit.

FIGS. 4A and 4B show the operation performed between the control circuit DKCTL0 and the storage modules STG0 to STG3, and how the values in the table MGTBL in DKCTL0 shift with this operation. In MGTBL, the data size ntW, and the data size Wh2d, data size Wstg, write data size ratio WAF (=Wstg/Wh2d) and predicted write data size eWd (=Wstg+ntW×WAF) for each of the storage modules STG0 to STG3, are held. As described with reference to FIG. 2, ntW is the data size of write data (WDT) included in a write access request (write command) (WREQ) that is the current processing target. Wh2d is the data size of write data (WDT) involved in a write access request (WREQ) that is already issued to a predetermined storage module by the control circuit DKCTL0. Wstg is the data size with which writing is actually performed by each of the storage modules STG0 to STG3 to its own non-volatile memories.

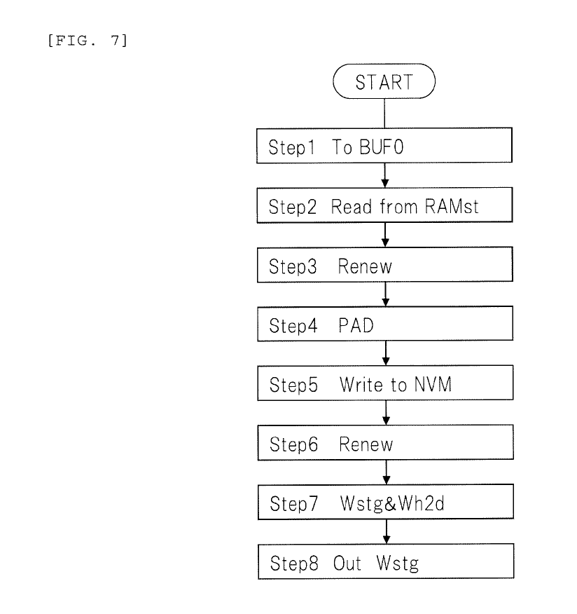

The data size Wh2d is the size of the write data (WDT) that is actually transmitted by the control circuit DKCTL0 itself to each of the storage modules STG0 to STG3 (equal to the size of the write data (WDATA) included in the write request (WQ) from the host) and therefore can be recognized by DKCTL0 itself. The data size Wstg is the size of the data that is actually written in the non-volatile memories NVM0 to NVM7 by the control circuit STCT in the storage module STG of FIG. 1 and therefore can be recognized by STCT. DKCTL0 can acquire this data size from STCT and thus recognize the data size. The values of Wh2d and Wstg are updated cumulatively, for example, from the first use of the storage module until the life thereof ends. Here, STCT increases the value of Wstg regardless of the write access request (write command) (WREQ) from DKCTL0, for example, when a garbage collection operation (+wear leveling operation) as described below with reference to FIG. 8 is performed, or when a static wear leveling operation is performed.

The static wear leveling operation may be, for example, for the purpose of reducing the difference between the number of writes at a data-valid physical address and the number of writes at a data-invalid physical address, though not particularly limiting. That is, a data-valid physical address continues to be valid unless a write command with respect to this physical address is generated, and consequently the number of writes at this physical address does not increase. However, a data-invalid physical address becomes a writing destination candidate after erasure, and therefore the number of writes at this physical address increases. Consequently, there are cases where the difference between the number of writes at a valid physical address and the number of writes at an invalid physical address may increase. Thus, it is possible to level the number of writes as a whole, for example, by using a static wear leveling operation to periodical move data at a physical address that is valid and has a small number of writes, to a physical address that is invalid and has a large number of writes, thus invalidate the physical address that is valid and has a small number of writes, of the data movement source, and validate the physical address that is invalid and has a large number of writes, of the data movement destination.

In the tables STGTBL shown in FIGS. 5A, 5B, 5C and 5D, the logical address (LAD) included in the write access request (write command) (WREQ), the numbers (STG No) of the storage modules STG0 to STG3 where the LAD data is stored, and validity information VLD indicating whether the LAD data is valid or invalid are stored. The logical address (LAD) included in the write access request (WREQ) is equal to the logical address included in the write request (write command) (WQ) from the information processing devices (hosts) SRV0 to SRVm, or univocally defined on the basis of the logical address included in the write request (WQ). If the validity information VLD is “1”, it means that the LAD data is valid. “0” means invalid. For example, in FIG. 5A as an example, it is shown that the data corresponding to the logical address LAD “0” is valid (validity information VLD=“1”) and stored in the storage module number “0” (that is, STG0). It is also shown that the data corresponding to the logical address LAD “1” is valid (validity information VLD=“1”) and stored in the storage module number “1” (that is, STG1).

Now, the flowchart of FIG. 3 will be described. First, the control circuit DKCTL0 issues a communication request for the data sizes Wstg and Wh2d to the storage modules STG0 to STG3 via the interface signal H2D_IF, according to need (for example, immediately after the power to the storage controller STRGCONT is turned on, or the like). In response to this, the respective storage modules STG0 to STG3 send back the data sizes Wstg (Wstg0(40), Wstg1(15), Wstg2(10), Wstg3(20)) and Wh2d (Wh2d0(10), Wh2d1(5), Wh2d2(5), Wh2d3(10)) to DKCTL0 (FIG. 3, Step 1, and FIG. 4A). To take Wstg0(40) as an example, in this case, the number “40” in the brackets expresses necessary information (here, data size).

Subsequently, the control circuit DKCTL0 sets these data sizes Wstg and Wh2d in the table MGTBL and thus updates MGTBL (FIG. 3, Step 2, and FIG. 4A). Here, it is assumed that DKCTL0 currently takes a write access request (write command) (WREQ[1]) including write data (WDT[1]) with a data size ntW1 (here, 10) and a logical address (here, 123), as a processing target. In this case, the write control circuit WTCTL in DKCTL0 finds the write data size ratio WAF for each of STG0 to STG3, using Wstg and Wh2d in MGTBL, and also finds the predicted write data size eWd, using ntW1, and sets these in MGTBL and thus updates MGTBL (FIG. 3, Step 3, and FIG. 4A). In the example of FIG. 4A, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=30, and eWd3=40, respectively.

Next, the write control circuit WTCTL in the control circuit DKCTL0 selects the storage module (here, STG2) in which the predicted write data size eWd is the smallest value (Min.) (FIG. 3, Step 4, and FIG. 4A). Next, if the data size Wstg is communicated from the storage modules STG0 to STG3, the processing goes to Step 2 and Steps 2 to 4 are executed again. Meanwhile, if Wstg is not communicated from STG0 to STG3, the processing goes to Step 6 (FIG. 3, Step 5).

In Step 6, the write control circuit WTCTL in the control circuit DKCTL0 issues a write access request (write command) (WREQ[1]) including write data (WDT[1]) with a data size ntW1 (=10) and a logical address LAD (=123), to the storage module STG2 selected in Step 4 (FIG. 4A). Next, WTCTL updates the table STGTBL on the basis of the correspondence between this LAD (=123) and STG2 (FIG. 3, Step 7, and FIG. 5A), and also updates the data size Wh2d in the table MGTBL (FIG. 3, Step 7, and FIG. 4B). That is, at LAD (=123) in STGTBL of FIG. 5A, the storage module number (STG No) is updated to “2” and the validity information VLD is updated to “1”. Also, at STG2 in MGTBL of FIG. 4B, Wh2d is updated from “5” to “15”.

Then, as the storage module STG2 completes writing of the write data (WDT[1]), the storage module STG2 communicates the data size Wstg (Wstg2(30)) to the control circuit DKCTL0 (FIG. 3, Step 8, and FIG. 4B), and returns to Step 2. In this example, in STG2, for example, the data size “20” is written through a garbage collection operation and a static wear leveling operation or the like during a period before writing the write data (WDT[1]) with the data size ntW1(=10). Therefore, a total value of “30” is communicated as Wstg2.

Subsequently, the write control circuit WTCTL in the control circuit DKCTL0 sets the communicated data size Wstg (Wstg2(30)) in the table MGTBL and thus updates MGTBL (FIG. 3, Step 2, and FIG. 4B). Here, it is assumed that DKCTL0 currently takes a write access request (write command) (WREQ[2]) including write data (WDT[2]) with a data size ntW2 (here, 10) and a logical address (here, 535), as a processing target. In this case, WTCTL finds the write data size ratio WAF for each of the storage modules STG0 to STG3, using the data sizes Wstg and Wh2d in MGTBL, and also finds the predicted write data size eWd, using ntW2, and sets these in MGTBL and thus updates MGTBL (FIG. 3, Step 3, and FIG. 4B). In the example of FIG. 4B, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=50, and eWd3=40, respectively.

Next, the write control circuit WTCTL in the control circuit DKCTL0 selects the storage module (here, STG3) in which the predicted write data size eWd is the smallest value (Min.) (FIG. 3, Step 4, and FIG. 4B). Next, if the data size Wstg is communicated from the storage modules STG0 to STG3, the processing goes to Step 2 and Steps 2 to 4 are executed again. Meanwhile, if Wstg is not communicated from STG0 to STG3, the processing goes to Step 6 (FIG. 3, Step 5).

In Step 6, the write control circuit WTCTL in the control circuit DKCTL0 issues a write access request (write command) (WREQ[2]) including write data (WDT[2]) with a data size ntW2 (=10) and a logical address LAD (=535), to the storage module STG3 selected in Step 4 (FIG. 4E). Next, WTCTL updates the table STGTBL on the basis of the correspondence between this LAD (=535) and STG3 (FIG. 3, Step 7, and FIG. 5B), and also updates the data size Wh2d in the table MGTBL (FIG. 3, Step 7). That is, at LAD (=535) in STGTBL of FIG. 5B, the storage module number (STG No) is updated to “3” and the validity information VLD is updated to “1”. Also, though not illustrated, at STG3 in MGTBL of FIG. 4B, Wh2d is updated from “10” to “20”.

Then, as the storage module STG3 completes writing of the write data (WDT[2]), STG3 communicates the data size Wstg to the control circuit DKCTL0 (FIG. 3, Step 8). The processing goes to Step 2 and similar processing is repeated afterward. In Step 6, at the storage modules to which a write access request (WREQ) is issued (here, STG2, STG3), the logical address LAD included in this write access request (WREQ) is converted to a physical address (PAD) in the non-volatile memories NVM0 to NVM7 and the write data is written at this converted physical address (PAD).

Here, the flowchart of FIG. 3 illustrates an example in which, in Step 1 (for example, immediately after the power is turned on), the control circuit DKCTL0 issues a communication request for data sizes Wstg and Wh2d to the storage modules STG0 to STG3 and thus acquires the values of Wstg and Wh2d, and in which the values of Wstg and Wh2d are subsequently updated at any time regardless of the communication request. That is, it is supposed that DKCTL0 itself updates the value of Wh2d while constantly grasping this value (Step 7), whereas DKCTL0 retracts the value of Wh2d into STG0 to STG3 at the time of power cutoff, for example, and reads out the value the next time the power is turned on (Step 1). Also, it is supposed, for example, that STG0 to STG3 constantly update the value of Wstg, and that the value of Wstg is automatically transmitted to DKCTL0 on completion of a write operation involved in a write access request (WREQ) (Step 8), so that DKCTL0 grasps the value of Wstg on the basis of this transmitted value (Step 2). In this case, in practice, STG0 to STG3 can stock a plurality of write access requests (WREQ) using internal buffers and therefore may transmit values of Wstg continuously, for example. Therefore, Step 5 is provided here.

However, as a matter of course, this flowchart is not limiting and can be changed according to need. For example, it is possible to employ a flow in which the control circuit DKCTL0 issues a communication request for Wstg to STG0 to STG3 immediately before issuing a write access request (WREQ), then STG0 to STG3 send back the value of Wstg only when the communication request is received, and in response to this, DKCTL0 selects the storage module to which WREQ is to be issued. Also, for example, it is possible to employ a flow in which STG0 to STG3 transmit the value of Wstg to DKCTL0 not only on completion of writing involved in a write access request (WREQ) but also on completion of writing involved in a garbage collection operation or the like (that is, transmits the value of Wstg at every update), and in response to this, DKCTL0 sequentially updates the value in the table MGTBL. In any case, it suffices to employ a flow in which DKCTL0 grasps the values of Wstg and Wh2d changing in time series, and selects the storage module to which a write access request (WREQ) is to be issued, on the basis of this information (that is, WAF (=Wstg/Wh2d)). Preferably, a flow in which the selection is made on the basis of WAF reflecting the latest circumstances, may be employed.

### Configuration of Storage Module (Memory Module)

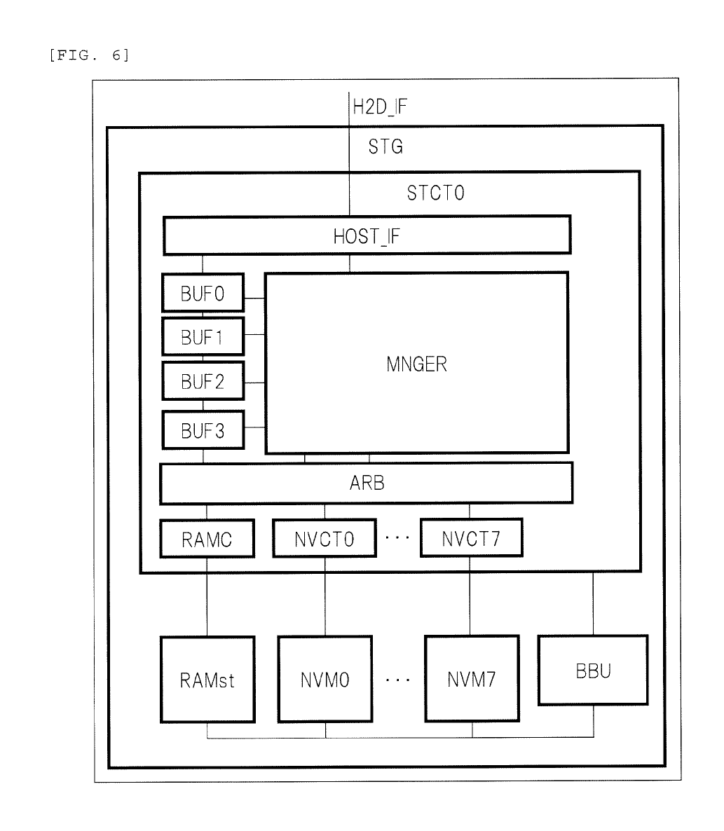

FIG. 6 is a block diagram showing a detailed configuration example of the storage module of FIG. 1. This storage module STG is used as the storage modules STG0 to STGn+4 of FIG. 1. The storage module STG shown in FIG. 6 has non-volatile memories NVM0 to NVM7, a random access memory RAMst, a storage control circuit STCT0 which controls NVM0 to NVM7 and RAMst, and a battery backup unit BBU. NVM0 to NVM7 have the same configuration and performance, for example. RAMst is, for example, a DRAM or the like though not particularly limiting. BBU is a device which has a large internal capacity to secure power for retracting the data in RAMst into NVM0 to NVM7 for a predetermined period, for example, at the time of unexpected power cutoff.

Immediately after the power is turned on, the storage module STG performs an initialization operation (so-called power-on reset) of the internal non-volatile memories NVM0 to NVM7, the random access memory RAMst, and the control circuit STCT0. Moreover, STG also performs initialization of the internal NVM0 to NVM7, RAMst, and STCT0 when a reset signal is received from the control circuit DKCTL0. STCT0 has an interface circuit HOST_IF, buffers BUF0 to BUF3, an arbiter circuit ARB, an information processing circuit MNGER, and memory control circuits RAMC and NVCT0 to NVCT7. The memory control circuit RAMC directly controls the random access memory RAMst. The memory control circuits NVCT0 to NVCT7 directly control the non-volatile memories NVM0 to NVM7, respectively.

In the random access memory RAMst, an address conversion table (LPTBL), a number of erasures table (ERSTBL), a physical block table (PBKTBL), a physical address table (PADTBL), and various other kinds of information are held. The address conversion table (LPTBL) shows the correspondence between the logical address (LAD) and the physical address (PAD) in the non-volatile memories NVM0 to NVM7. The number of erasures table (ERSTBL) shows the number of erasures for each physical block. The physical block table (PBKTBL) shows the state of each physical block, such as whether the physical block is in the erased state, partly written, or totally written, and the total number of invalid physical addresses for each physical block (INVP). The physical address table (PADTBL) shows whether data at each physical address is valid or invalid, or whether each physical address is in the erased state. Here, a physical block represents a unit area of erasure. Each physical block is composed of a plurality of physical addresses that are unit areas of writing. Also, the various other kinds of information in the random access memory RAMst includes the number of physical blocks in the erased state (Esz) in the storage module STG, and the foregoing data sizes Wstg and Wh2d, or the like.

### Wear Leveling Within Storage Module

FIG. 7 is a flowchart showing an example of a wear leveling method performed within the storage module of FIG. 1. FIG. 7 shows an example of a write processing procedure performed within STG0 to STGn+4 when a write access request (write command) (WREQ) is issued from the control circuit DKCTL0 of FIG. 1 to the storage modules STG0 to STGn+4, and an example of a wear leveling (that is, dynamic wear leveling) method performed at the time of this writing. Also, the flow of FIG. 7 is executed mainly by the information processing circuit MNGER of FIG. 6. MNGER allocates one physical address (PAD) based on 512-byte main data and 16-byte redundant data as a unit, though not particularly limiting, and performs writing to this physical address (PAD) in the non-volatile memories NVM0 to NVM7.

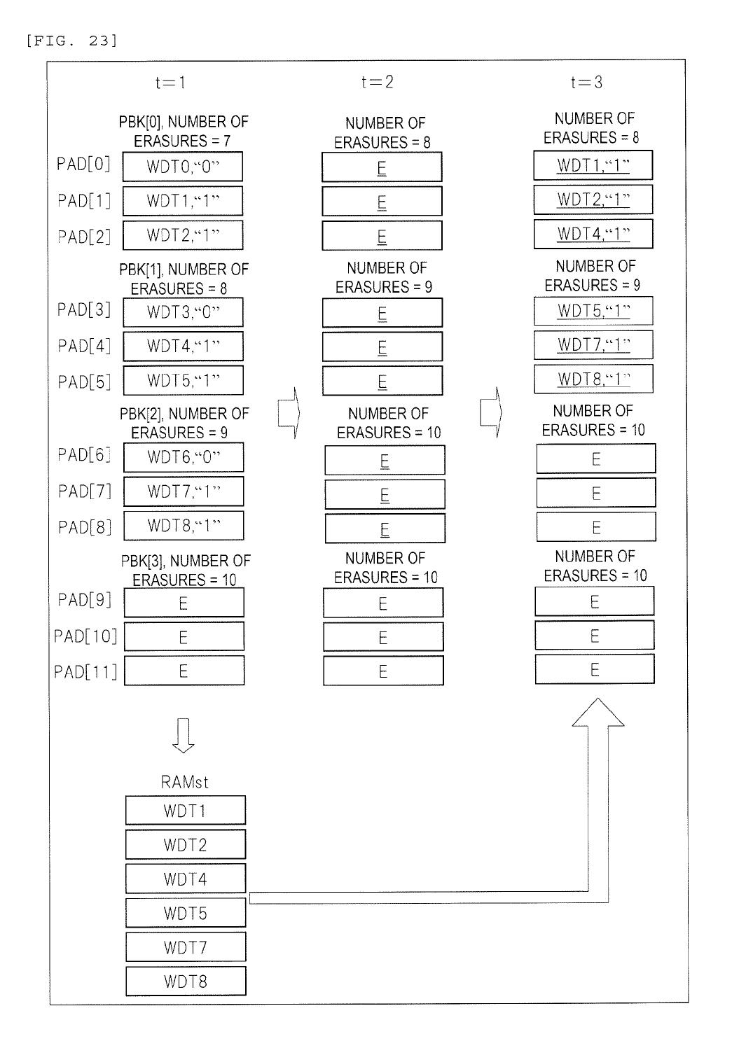

FIG. 22 is a supplementary diagram for roughly explaining the flow of FIG. 7. Using the flow of FIG. 7, the operation roughly as shown in FIG. 22 is carried out. In the example of FIG. 22, it is assumed that a physical block PBK[0] is composed of three physical addresses PAD[0] to PAD[2], and that similarly, physical blocks PBK[1] and PBK[2] are each composed of three physical addresses PAD[3] to PAD[5] and PAD[6] to PAD[8], respectively. It is assumed that the number of erasures for PBK[0] PBK[1], and PBK[2] is 10, 9, and 8, respectively, and that PBK[1] and PBK[2] are in the erased state (E). Also, it is assumed that at PAD[0], PAD[1], and PAD[2], write data WDT0, WDT1, and WDT2 with logical addresses LAD[0], LAD[1], and LAD[2] are written, respectively, and that all of PAD[0], PAD[1], and PAD[2] (WDT0, WDT1, and WDT2) are valid “1”.

From such a state (t=1), it is assumed, for example, that at t=2, a write access request (write command) (WREQ[3]) including a logical address LAD[0] and write data WDT3 is inputted. In this case, the information processing circuit MNGER first changes the physical address PAD[0] corresponding to LAD[0] from valid “1” to invalid “0”, and decides a new physical address to which WDT3 with this LAD[0] is to be written. At this point, of the physical blocks in the erased state or partly written, the physical block with the smallest number of erasures (here, PBK[2]) is selected. Then, WDT3 is written to the first physical address in the erased state (here, PAD[6]) within this physical block (PBK[2]), and this PAD[6] is made valid “1”. Afterward, for example, when a write access request (WREQ[4]) including LAD[0] and write data WDT4 is inputted at t=3, MNGER similarly makes PAD[6] invalid “0” and selects the physical block that is partly written and that has the smallest number of erasures (here, PBK[2]). Then, WDT4 is written to the first physical address (here, PAD[7]) in the erased state within this physical block (PBK[2]), and this PAD[7] is made valid “1”.

Such an operation is performed using the flow of FIG. 7. In FIG. 7, first, a write access request (write command) (WREQ[3]) including a logical address value (for example, LAD[0]), a data write command (WRT), a sector count value (for example, SEC=1) and 512-byte write data (for example, WDT3) is inputted from the control circuit DKCTL0 to the control circuit STCT0. The control circuit HOST_IF takes out clock information embedded in the write access request (WREQ[3]), converts the write access request (WREQ[3]) in the form of serial data to parallel data, and transfers the data to the buffer BUF0 and the information processing circuit MNGER (Step 1).

Next, the information processing circuit MNGER deciphers the logical address value (LAD[0]), the data write command (WRT) and the sector count value (SEC=1) and searches the address conversion table (LPTBL) in the random access memory RAMst. Thus, the information processing circuit MNGER reads out the current physical address value (for example, PAD[0]) stored at the address of the logical address value (LAD[0]), and the value of the validity flag PVLD corresponding to this physical address value (PAD[0]) (Step 2). Moreover, if this validity flag PVLD value is “1 (valid)”, this is then made “0 (invalid)”, thus updating the address conversion table (LPTBL) and the physical address table (PADTBL) (Step 3).

Subsequently, the information processing circuit MNGER extracts physical blocks that are in the erased state or partly written, from the physical block table (PBKTBL) in the random access memory RAMst, and then selects the physical block (for example, PBK[2]) having the smallest number of erasures of the extracted physical blocks, using the number of erasures table (ERSTBL) in RAMst. Then, MNGER selects the smallest physical address (for example, PAD[6]) of the physical addresses (in the erased state) at which data is not written yet, in the selected physical block, using the physical address table (PADTBL) (Step 4).

Next, the information processing circuit MNGER writes the 512-byte write data (WDT3) to the physical address (PAD[6]) (Step 5). Subsequently, MNGER updates the address conversion table (LPTBL) and the physical address table (PADTBL) (Step 6). Moreover, MNGER recalculates the data sizes Wstg (and Wh2d) and stores the data sizes in the random access memory RAMst (Step 7). Finally, MNGER transmits the value of the latest data size Wstg to the control circuit DKCTL0 via the control circuit HOST_IF and the interface signal H2D_IF (Step 8).

As described above, inside the storage module (memory module) STG, leveling is performed by writing data in order from the physical address with the smallest value of the number of erasures. Therefore, by combining this with the leveling among the storage modules STG as described with reference to FIG. 3 and the like, it is possible to realize further leveling as the whole storage system (storage device system) STRGSYS of FIG. 1.

### Garbage Collection (+Wear Leveling) Within Storage Module

FIG. 8 is a flowchart showing an example of a garbage collection and wear leveling method performed within the storage module of FIG. 1. FIG. 23 is a supplementary diagram for roughly explaining the flow of FIG. 8. The flow of FIG. 8 is executed mainly by the information processing circuit MNGER of FIG. 6. As data continues to be written in the non-volatile memories NVM0 to NVM7, the number of physical addresses (number of physical blocks) in the erased state decreases. When the number of physical addresses (number of physical blocks) in the erased state becomes 0, the storage module STG can no longer perform writing. Thus, a garbage collection operation to increase the number of physical addresses (number of physical blocks) in the erased state is needed. Then, at the time of this garbage collection operation, it is desirable to perform a wear leveling operation as well. Thus, executing the flow of FIG. 8 is advantageous.

In FIG. 8, the information processing circuit MNGER of FIG. 6 first reads out the number of physical blocks in the erased state Esz stored in the random access memory RAMst (Step 1). Next, Esz is compared with a predetermined threshold DERCth of the number of physical blocks in the erased state (Step 2). In the case of Esz≧DERCth, the processing goes to Step 1. In the case of Esz<DERCth, the processing goes to Step 3. In Step 3, MNGER reads out the number of erasures table (ERSTBL), the physical block table (PBKTBL) and the physical address table (PADTBL) stored in RAMst. The number of erasures for each physical block is found on the basis of ERSTBL. The state of each physical block (erased data, partly written, totally written) and the number of invalid physical addresses (INVP) in each physical block are found on the basis of PBKTBL. Whether each physical address is valid or invalid is found on the basis of PADTBL.

Next, with respect to the totally written physical blocks, the information processing circuit MNGER sequentially selects totally the written physical blocks in order from the smallest value of the number of erasures until the sum of the numbers of invalid physical addresses (INVP) reaches the size of the physical block or above (Step 4). Here, for example, the case as shown in FIG. 23 is supposed. In the example of FIG. 23, it is assumed that a physical block PBK[0] is composed of three physical addresses PAD[0] to PAD[2], and that similarly, physical blocks PBK[1], PBK[2], and PBK[3] are each composed of three physical addresses PAD[3] to PAD[5], PAD[6] to PAD[8], and PAD[9] to PAD[11], respectively. It is assumed that the number of erasures for PBK[0], PBK[1], PBK[2], and PBK[3] is 7, 8, 9, and 10, respectively, and that these are in the erased state (E). Also, it is assumed that at PAD[0] to PAD[8], write data WDT0 to WDT8 are written, respectively, and that PAD[0], PAD[3], and PAD[6] of them (WDT0, WDT3, and WDT6) are invalid “0”.

In such a state (t=1), if, for example, the number of physical blocks in the erased state needs to be 2 or above (FIG. 8, Step 2), a garbage collection operation is executed. In the example of FIG. 23, the physical blocks PBK[0], PBK[1], and PBK[2] are selected in Step 4 of FIG. 8. Subsequently, in Step 5 of FIG. 8, the information processing circuit MNGER reads out the data at valid physical addresses in these selected physical blocks and temporarily stores the data in the random access memory RAMst. In the example of FIG. 23, the write data WDT1, WDT2, WDT4, WDT5, WDT7, and WDT8 are stored in RAMst. Afterward, MNGER erases these selected physical blocks (FIG. 8, Step 6, and t=2 in FIG. 23).

Then, in Step 7 of FIG. 8, the information processing circuit MNGER writes the write data that are temporarily stored in the random access memory RAMst, back into the physical blocks in the erased state in the non-volatile memories NVM0 to NVM7. By this, a garbage collection operation is realized. Moreover, at the time of writing back, physical blocks are selected in order from the smallest value of the number of erasures, of the physical blocks in the erased state, so as to perform the writing back. Thus, a wear leveling operation is realized simultaneously with the garbage collection operation. In the example of FIG. 23, as shown at t=3, the two physical blocks PEK[0] and PBK[1] are selected in order from the smallest value of the number of erasures, and the write data WDT1, WDT2, WDT4, WDT5, WDT7, and WDT8 in RAMst are written back into these physical blocks. Consequently, one physical block in the eased state (here, PBK[2]) is generated in addition to the physical block PBK[3].

Next, in Step 8 of FIG. 8, the information processing circuit MNGER updates the address conversion table (LPTBL), the number of erasures table (ERSTBL), the physical block table (PBKTBL), the physical address table (PADTBL), and the number of physical blocks in the erased state Esz, in the random access memory RAMst. MNGER also updates the data size Wstg in the RAMst that is the size of data actually written in the non-volatile memories NVM0 to NVM7 by the storage module STG. Finally, MNGER transfers the latest data size Wstg to the control circuit DKCTL0 via the interface circuit HOST_IF and the interface signal H2D_IF (Step 9).

By performing the garbage collection operation and the wear leveling operation (so to speak, static wear leveling operation) as described above, it is possible to realize the leveling of the number of erasures within the storage module (memory module) STG along with the dynamic wear leveling operation as shown in FIG. 7. Although this may cause a variation in the number of erasures among the storage modules STG in some cases, the variation can be leveled by the operation as shown in FIG. 3 and the like, and consequently further leveling can be realized in the storage system (storage device system) STRGSYS of FIG. 1 as a whole.

### Reading Method

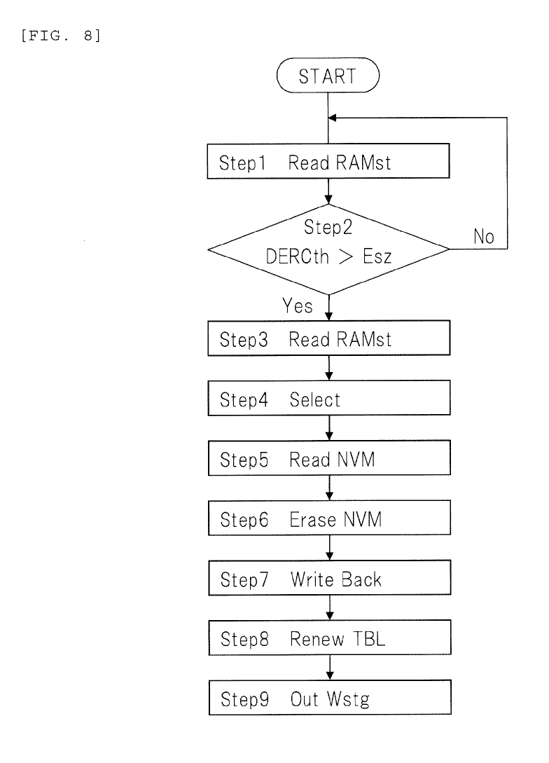

As described above, the host control circuit HCTL0 in the storage controller STRGCONT receives a read request (RQ) from the information processing devices (hosts) SRV0 to SRVm, notifies the storage module control circuit DKCTL0 if corresponding data (RDATA) is not stored in the cache memories CM0 to CM3. FIG. 9 is a flowchart showing a read operation example performed by the storage module control circuit and the storage control circuit of FIG. 1, and showing an operation example after DKCTL0 receives a read request (RQ) in response to the communication from HCTL0.

First, the control circuit DKCTL0 in the storage controller STRGCONT receives a read request (RQ) including a logical address value (for example, LAD=535), a data read command (RD) and a sector counter value (SEC=1), via the control circuit HCTL0. In response to this, the read control circuit RDCTL in DKCTL0 reads out the storage module number (STG No) and the validation flag VLD corresponding to the logical address value (LAD=535) from the table STGTBL (Step 1). In the example of FIG. 5B, the storage module number “3” and VLD=“1” are read out.

Next, the read control circuit RDCTL checks whether the read-out validity flag VLD is “1” or not (Step 2). Here, if VLD is “0”, RDCTL recognizes that a storage module STG is not allocated to this logical address value (LAD=535). In this case, since data cannot be read out from a storage module STG, RDCTL communicates to the control circuit HCTL0 that an error is generated (Step 10). Meanwhile, if VLD is “1”, RDCTL determines that the storage module STG3 corresponds to this logical address value (LAD=535) and issues a read access request (RREQ) to STG3 (Step 3).

Subsequently, the interface circuit HOST_IF in the storage module STG3 takes out clock information embedded in the read access request (RREQ) issued from the control circuit DKCTL0, converts RREQ in the form of serial data to parallel data, and transfers the data to the buffer BUF0 and the information processing circuit MNGER (Step 4). The information processing circuit MNGER deciphers the logical address value (LAD=353), the data read command (RD) and the sector count value (SEC=1) included in this read access request (RREQ), and reads out various kinds of information, referring to the address conversion table (LPTBL) saved in the random access memory RAMst. Specifically, the physical address value (for example, PAD=33) stored at the logical address LAD of 535 in LPTBL, and the validity flag PVLD corresponding to this physical address PAD are read out (Step 5). Next, whether the read-out validity flag PVLD is “1” or not is checked (Step 6).

Here, if the validity flag PVLD is “0”, the information processing circuit MNGER recognizes that a physical address PAD is not allocated in this logical address value (LAD=535). In this case, since data cannot be read out from the non-volatile memories NVM0 to NVM7, MNGER communicates that an error is generated, to the read control circuit RDCTL in the control circuit DKCTL0 via the interface circuit HOST_IF (Step 11). Meanwhile, if the validity flag PVLD is “1”, MNGER determines that the physical address value (PAD=33) corresponds to this logical address value (LAD=535).

Next, the information processing circuit MNGER converts the physical address value (PAD=33) corresponding to the logical address value (LAD=535), to a chip address (CHIPA), a bank address (BK), a row address (ROW), and a column address (COL) in the non-volatile memories NVM0 to NVM7. Then, MNGER inputs the converted address to the non-volatile memories NVM0 to NVM7 via the arbiter circuit ARE and the memory control circuits NVCT0 to NVCT7, and reads out data (RDATA) stored in NVM0 to NVM7 (Step 7).

Here, the read-out data (RDATA) includes main data (DArea) and redundant data (RArea). The redundant data (RArea) further includes an ECC code (ECC). Thus, the information processing circuit MNGER checks whether there is an error in the main data (DArea), using the ECC code (ECC). If these is an error, MNGER corrects the error and transmits the data (RDATA) to the control circuit DKCTL0 via the interface circuit HOST_IF (Step 8). DKCTL0 transfers the transmitted data (RDATA) to the cache memories CM0 to CM3 and also transmits the data to the information processing devices SRV0 to SRVm via the control circuit HCTL0 and the interface signal H2S_IF (Step 9).

As described above, by using the storage device system of this Embodiment 1, typically, it is possible to realize the leveling of the number of erasures (and consequently the leveling of the number of writes) in the storage device system as a whole, and to realize improved reliability and a longer life or the like.

### Embodiment 2

In this Embodiment 2, a method using a data retention time Ret in addition to the foregoing predicted write data size eWd will be described as a modification of the method for wear leveling among storage modules according to Embodiment 1 described with reference to FIGS. 3, 4A and 4B or the like.

### Outline of Data Retention Time

In a non-volatile memory (particularly a destructive write-type memory such as flash memory), in some cases, the data retention time (that is, over what period the written data can be held correctly) may decrease as the number of erasures (or the number of writes) increases. Although not particularly limiting, the data retention time is 10 years or the like if the number of writes is small, for example. To what extent this data retention time depends on the number of erasures (or the number of writes) changes, depending on what kind of non-volatile memory is used for the storage module. For example, this can vary according to whether a flash memory is used or a phase-change memory is used as a non-volatile memory, and what kind of memory cell structure is used in the case where a flash memory is used, or the like.

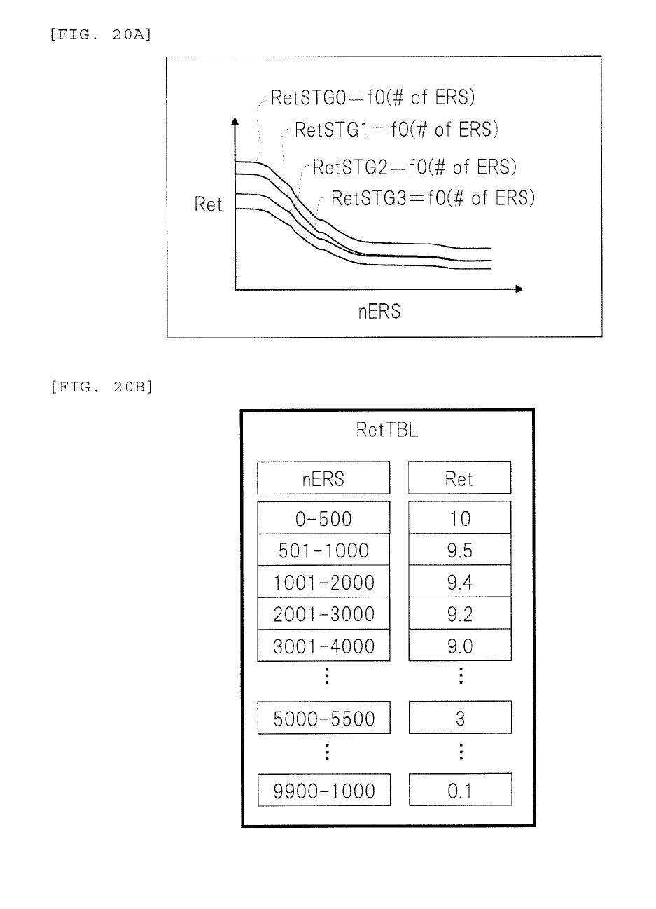

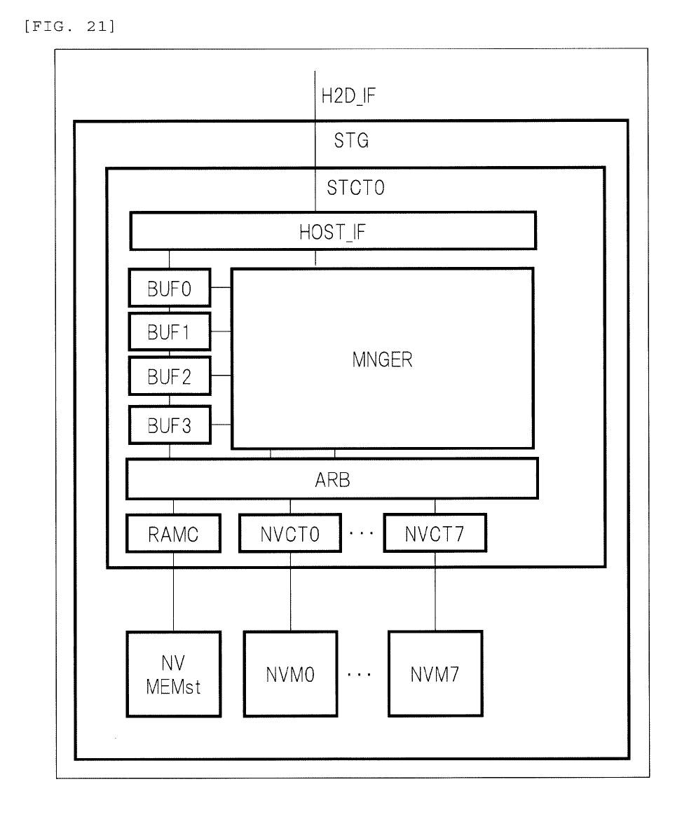

FIG. 20A is an explanatory diagram showing an example of data holding characteristics of the storage module in the storage device system according to Embodiment 2 of the invention. FIG. 20A shows the dependence relation (function) between the number of erasures (or the number of writes) (nERS) and the data holding time (data retention time) Ret, of the physical blocks. In FIG. 20A, RetSTG0 to RetSTG3 represent the dependence relations (functions) in the storage modules STG0 to STG3, respectively.

Each of the storage modules (memory modules) STG0 to STG3 holds in advance its own dependence relation (function between the number of erasures (or the number of writes) and the data holding time, in the non-volatile memories NVM0 to NVM7 as a mathematical formula, and transfers the mathematical formula to the random access memory RAMst immediately after the power is turned on in STG0 to STG3. The information processing circuit MNGER in the storage control circuit STCT finds a maximum value of the number of erasures of the respective physical blocks in NVM0 to NVM7. Then, every time this maximum value changes, MNGER reads out the mathematical formula from RAMst, calculates the data holding time (data retention time) Ret, using this maximum value of the number of erasures (nERS) as an argument, and stores the data retention time in RAMst. Moreover, each of STG0 to STG3 transfers the calculated data retention time Ret to the storage controller STRGCONT, according to need.

FIG. 20B is a diagram showing an example in which the data holding characteristics of FIG. 20A are prescribed in a table. In FIG. 20A, the dependence relation (function) is prescribed by a mathematical formula in advance and thereby the data retention time Ret is calculated. It is possible instead to prescribe a table RetTBL as shown in FIG. 20B which discretely represents the mathematical formula, and thereby calculate the data retention time Ret. FIG. 20B shows a table RetTBL held by one storage module STG. In this RetTBL, the dependence relation (function) between the number of erasures (or the number writes) (nERS) and the data retention time Ret of the physical blocks is prescribed.

Each of the storage modules STG0 to STG3 holds in advance a table RetTBL corresponding to its own characteristics, in the non-volatile memories NVM0 to NVM7, and transfers this table RetTBL to the random access memory RAMst immediately after the power is turned on in STG0 to STG3. The information processing circuit MNGER in the storage control circuit STCT finds a maximum value of the number of erasures of the respective physical blocks in NVM0 to NVM7. Then, every time this maximum value changes, MNGER searches the table RetTBL and acquires the data holding time (data retention time) Ret. Moreover, each of STG0 to STG3 transfers the acquired data retention time Ret to the storage controller STRGCONT, according to need.

As shown in FIG. 20A, the data retention time Ret of the storage module differs from one storage module to another, and decreases on the basis of a predetermined dependence relation (function) every time the number of erasures (or the number of writes) (nERS) increases. The data retention time Ret represents the remaining life of the corresponding storage module. As this time falls below a predetermined value, the life of this storage module ends. Therefore, even if the leveling of the number of erasures (or the number of writes) among the storage modules is performed using the method of Embodiment 1, in some cases, there may be a variation among the storage modules in terms of the data retention time Ret, as can be seen from FIG. 20A. Consequently, there is a risk that the life of the storage device system as a whole may be reduced.

Thus, for example, a threshold of the data retention time (remaining life) Ret may be provided. This threshold may be properly controlled and the leveling of the number of erasures among the storage modules as described in Embodiment 1 may be performed in the state where the data retention time Ret of each storage module can be constantly kept equal to or above the threshold. For example, in FIG. 20A, if the storage modules STG0 and STG3 have the same number of erasures (nERS) and the data retention time Ret of STG3 reaches the threshold in this state, write and erasure may be performed to STG0, without performing write and erasure to STG3 for some time.

### Wear Leveling Among Storage Modules (Modification)

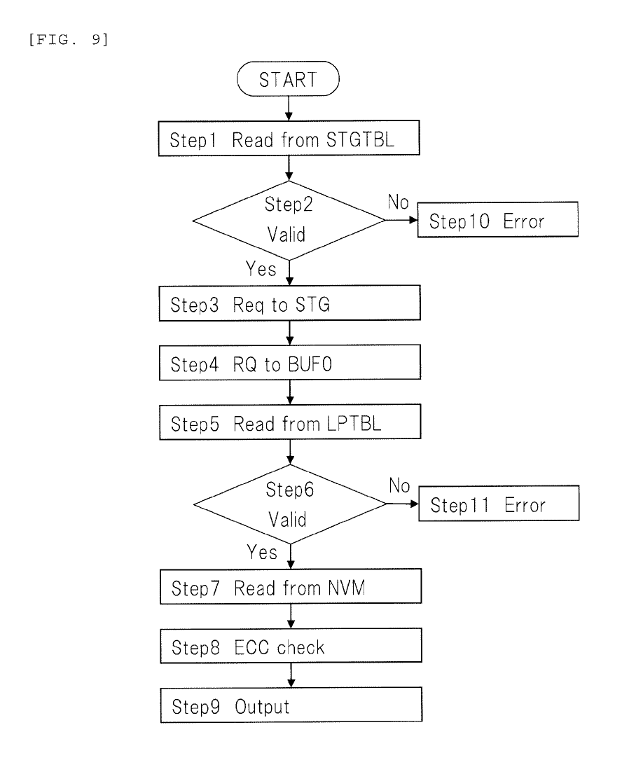

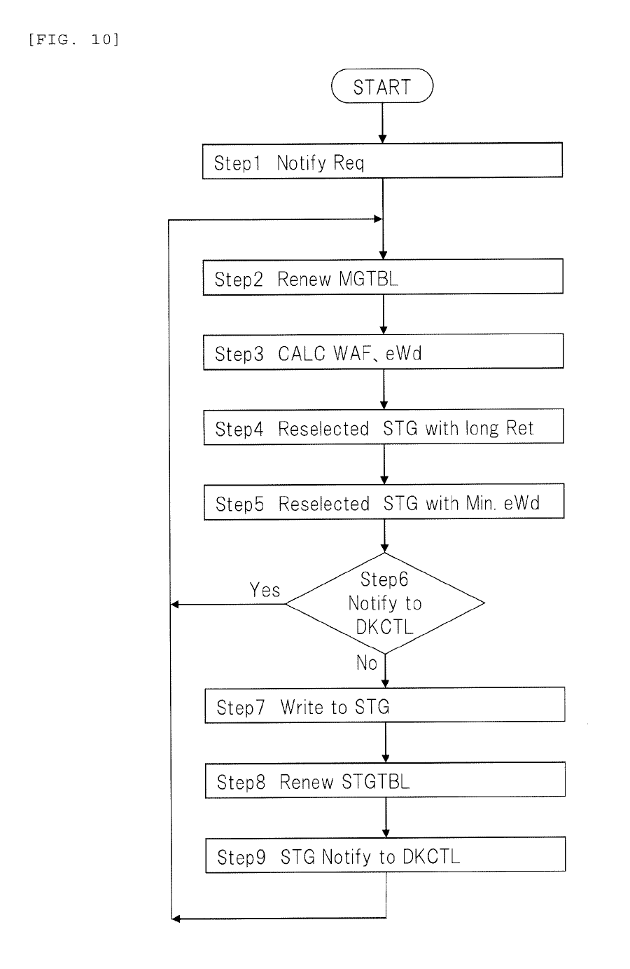

Hereinafter, the write operation executed by the control circuit DKCTL0 will be described using FIGS. 5A and 5B as well as FIGS. 10 and 11, taking the case where the four storage modules STG0 to STG3 are provided, as an example, though this is not particularly limiting. FIG. 10 is a flowchart showing an example of the write operation performed by the storage module control circuit of FIGS. 1 and 2 in the storage device system according to Embodiment 2 of the invention. FIGS. 11A and 119 are supplementary diagrams of FIG. 10, showing an example of the content held in the table MGTBL held in the storage module control circuit. In the tables MGTBL shown in FIGS. 11A and 11B, the data retention time Ret for each of STG0 to STG3 is held, in addition to the data size ntW, and the data sizes Wh2d and Wstg, the write data size ratio WAF and the predicted write data size eWd for each of the storage modules STG0 to STG3, shown in FIG. 4 and the like.

First, the control circuit DKCTL0 issues a communication request for the data retention time Ret and the data sizes Wstg and Wh2d to the storage modules STG0 to STG3 via the interface signal H2D_IF, according to need (for example, immediately after the power to the storage controller STRGCONT is turned on, or the like). In response to this, the respective storage modules STG0 to STG3 send back the data retention times Ret (Ret0(8), Ret1(6), Ret2(9), Ret3(7)) to DKCTL0. The storage modules also send back the data sizes Wstg (Wstg0(40), Wstg1(15), Wstg2(10), Wstg3(20)) and Wh2d (Wh2d0(10), Wh2dl (5), Wh2d2(5), Wh2d3 (10)) to DKCTL0 (FIG. 10, Step 1, and FIG. 11A).

Subsequently, the control circuit DKCTL0 sets these data retention times Ret and data sizes Wstg and Wh2d in the table MGTBL and thus updates MGTBL (FIG. 10, Step 2, and FIG. 11A). Here, it is assumed that DKCTL0 currently takes a write access request (write command) (WREQ[1]) including write data (WDT[1]) with a data size ntW1 (here, 10) and a logical address (here, 123), as a processing target. In this case, the write control circuit WTCTL in DKCTL0 finds the write data size ratio WAF for each of STG0 to STG3, using Wstg and Wh2d in MGTBL, and also finds the predicted write data size eWd, using ntW1, and sets these in MGTBL and thus updates MGTBL (FIG. 10, Step 3, and FIG. 11A). In the example of FIG. 11A, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=30, and eWd3=40, respectively.

Next, the write control circuit WTCTL compares the life information (dLife (here, 4.5)) of the storage system (storage device system) STRGSYS with the data retention times Ret (Ret0(8), Ret1(6), Ret2(9), Ret3(7)) of the respective storage modules STG0 to STG3. Then, WTCTL selects a storage module having a data retention time (remaining life) Ret equal to or longer than the life information (dLife) of the storage system (FIG. 10, Step 4, and FIG. 11A).

Subsequently, the write control circuit WTCTL further selects the storage module (here, STG2) in which the predicted write data size eWd is the smallest value (Min.), from among the storage modules selected in Step 4 (FIG. 10, Step 5, and FIG. 11A). Next, if the data size Wstg is communicated from the storage modules STG0 to STG3, the processing goes to Step 2 and Steps 2 to 5 are executed again. Meanwhile, if Wstg is not communicated from STG0 to STG3, the processing goes to Step 7 (FIG. 10, Step 6).

In Step 7, the write control circuit WTCTL issues a write access request (write command) (WREQ[1]) including write data (WDT[1]) with a data size ntW1 (=10) and a logical address LAD (=123), to the storage module STG2 selected in Step 5 (FIG. 11A). Next, WTCTL updates the table STGTBL on the basis of the correspondence between this LAD (=123) and STG2 (FIG. 10, Step 8, and FIG. 5A), and also updates the data size Wh2d in the table MGTBL (FIG. 10, Step 8, and FIG. 11B). That is, at LAD (=123) in STGTBL of FIG. 5A, the storage module number (STG No) is updated to “2” and the validity information VLD is updated to “1”. Also, at STG2 in MGTBL of FIG. 11B, Wh2d is updated from “5” to “15”.

Then, as the storage module STG2 completes writing of the write data (WDT[1]), the storage module STG2 communicates the data retention time Ret (8.9) the data size Wstg (Wstg2(30)) to the control circuit DKCTL0 (FIG. 10, Step 9, and FIG. 11E), and returns to Step 2. In this example, in STG2, for example, the data size “20” is written through a garbage collection operation and a static wear leveling operation or the like during a period before writing the write data (WDT[1]) with the data size ntW1(=10). Therefore, a total value of “30” is communicated as Wstg2. Also, the data retention time Ret (8.9) is calculated by the information processing circuit MNGER, as described with reference to FIGS. 20A and 20E, and is decreased here from “9” of FIG. 11A to “8.9” of FIG. 11B via this garbage collection operation and the like.

Subsequently, the write control circuit WTCTL sets the communicated data retention time Ret(8.9) and data size Wstg (Wstg2(30)) in the table MGTBL and thus updates MGTBL (FIG. 10, Step 2, and FIG. 11B). Here, it is assumed that DKCTL0 currently takes a write access request (write command) (WREQ[2]) including write data (WDT[2]) with a data size ntW2 (here, 10) and a logical address (here, 535), as a processing target. In this case, WTCTL finds the write data size ratio WAF for each of the storage modules STG0 to STG3, using the data sizes Wstg and Wh2d in MGTBL, and also finds the predicted write data size eWd, using ntW2, and sets these in MGTBL and thus updates MGTBL (FIG. 10, Step 3, and FIG. 11B). In the example of FIG. 11B, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=50, and eWd3=40, respectively.

Next, the write control circuit WTCTL compares the life information dLife (=4.5) of the storage system with the data retention times Ret (Ret0(8), Ret1(6), Ret2(8.9), Ret3(7)) of the respective storage modules STG0 to STG3. Then, WTCTL selects a storage module having a data retention time Ret equal to or longer than the life information dLife(4.5) of the storage system (FIG. 10, Step 4, and FIG. 11B).

Although the life information (threshold of the remaining life) dLife does not change here, it is variably controlled appropriately in practice. On the basis of the specifications of the storage system, for example, the write control circuit WTCTL can take into consideration the increase in the period of use of this system (in other words, the decrease in the remaining life), and set the life information (threshold of the remaining life) dLife decreasing with time, reflecting this remaining life, though this is not particularly limiting. In this case, in the storage system, the minimum necessary remaining life can be secured according to the period of use, and improved reliability and a longer life or the like are achieved. Also, WTCTL can set dLife in such a way that, for example, every time the data retention time Ret of the majority of the storage modules reaches the life information (threshold of the remaining life) dLife, the value thereof is gradually decreased. In this case, the leveling of the data retention time Ret between the storage systems can be performed, and improved reliability and a longer life or the like are achieved.

Subsequently, the write control circuit WTCTL further selects the storage module (here, STG3) in which the predicted write data size eWd is the smallest value (Min.), from among the storage modules selected in Step 4 (FIG. 10, Step 5, and FIG. 11B). Next, if the data size Wstg is communicated from the storage modules STG0 to STG3, the processing goes to Step 2 and Steps 2 to 5 are executed again. Meanwhile, if Wstg is not communicated from STG0 to STG3, the processing goes to Step 7 (FIG. 10, Step 6).

In Step 7, the write control circuit WTCTL in the control circuit DKCTL0 issues a write access request (write command) (WREQ[2]) including write data (WDT[2]) with a data size ntW2 (=10) and a logical address LAD (=535), to the storage module STG3 selected in Step 5 (FIG. 11B). Next, WTCTL updates the table STGTBL on the basis of the correspondence between this LAD (=535) and STG3 (FIG. 10, Step 8, and FIG. 5B), and also updates the data size Wh2d in the table MGTBL (FIG. 10, Step 8). That is, at LAD (=535) in STGTBL of FIG. 5B, the storage module number (STG No) is updated to “3” and the validity information VLD is updated to “1”. Also, though not illustrated, at STG3 in MGTBL of FIG. 11B, Wh2d is updated from “10” to “20”.

Then, as the storage module STG3 completes writing of the write data (WDT[2]), STG3 communicates the data size Wstg to the control circuit DKCTL0 (FIG. 10, Step 9). The processing goes to Step 2 and similar processing is repeated afterward. In Step 7, at the storage modules to which a write access request (WREQ) is issued (here, STG2, STG3), the logical address LAD included in this write access request (WREQ) is converted to a physical address (PAD) in the non-volatile memories NVM0 to NVM7 and the write data is written at this converted physical address (PAD).

As described above, by using the storage device system of this Embodiment 2, typically, it is possible to realize the leveling of the number of erasures (and consequently the leveling of the number of writes) in the storage device system as a whole, and to realize improved reliability and a longer life or the like, as in the case of Embodiment 1. Moreover, it is possible to realize further improved reliability and a much longer life or the like, by the management of the data retention time (remaining life).

### Embodiment 3

In this Embodiment 3, the case where the storage module control circuit DKCTL0 performs management of garbage collection in addition to the execution of the wear leveling among the storage modules according to Embodiment 1 described with reference to FIGS. 3, 4A and 4B or the like, will be described.

### Wear Leveling Among Storage Modules+Garbage Collection Management

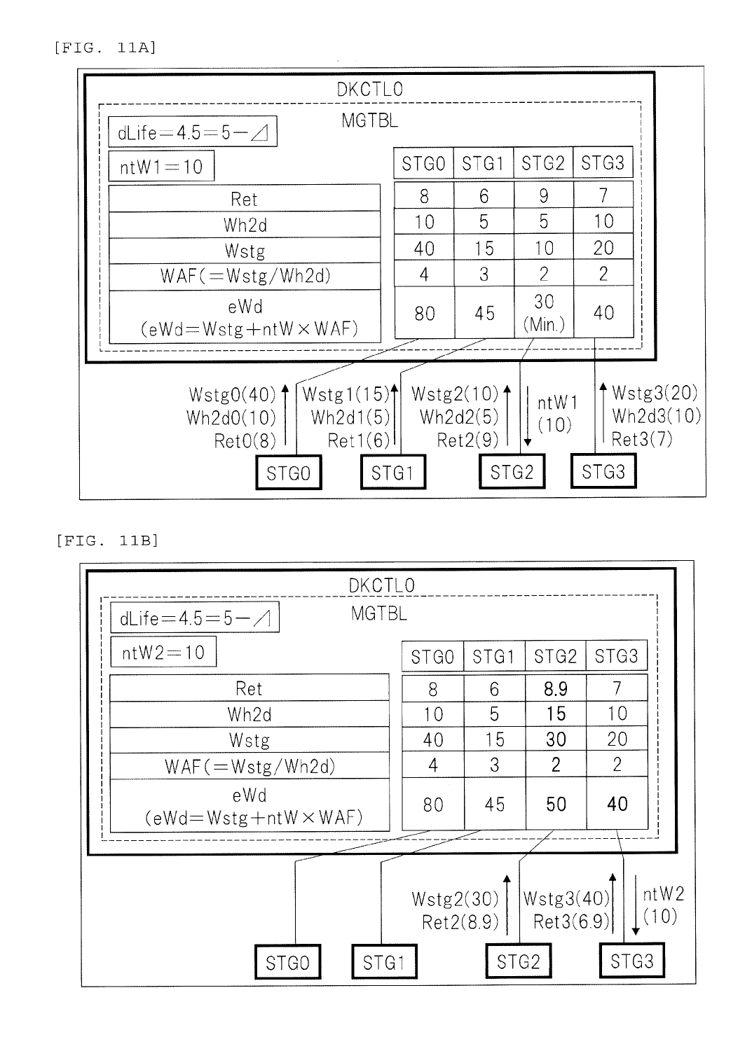

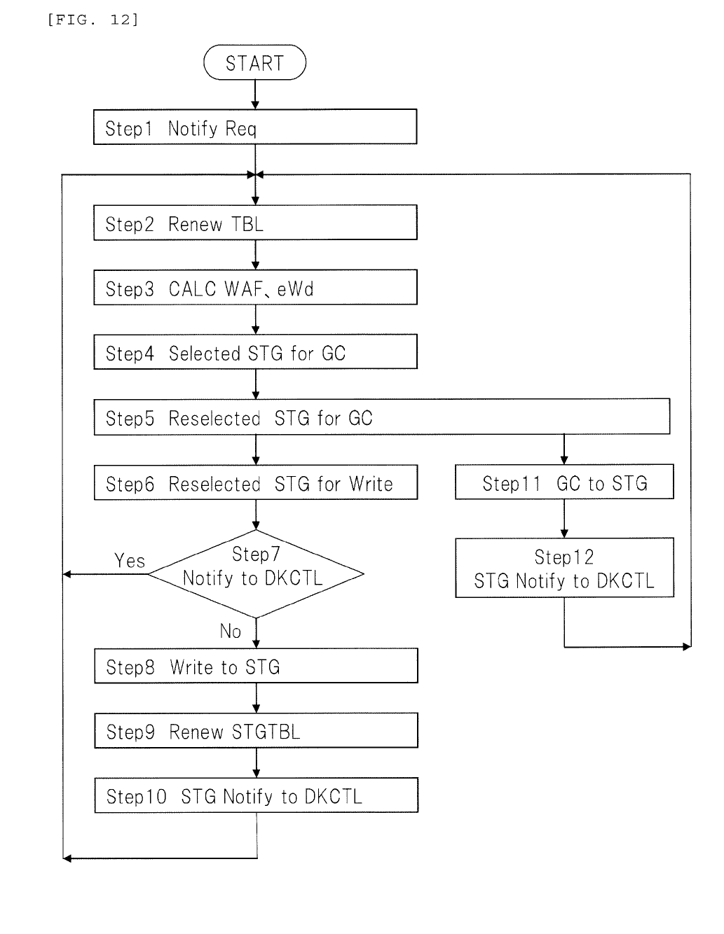

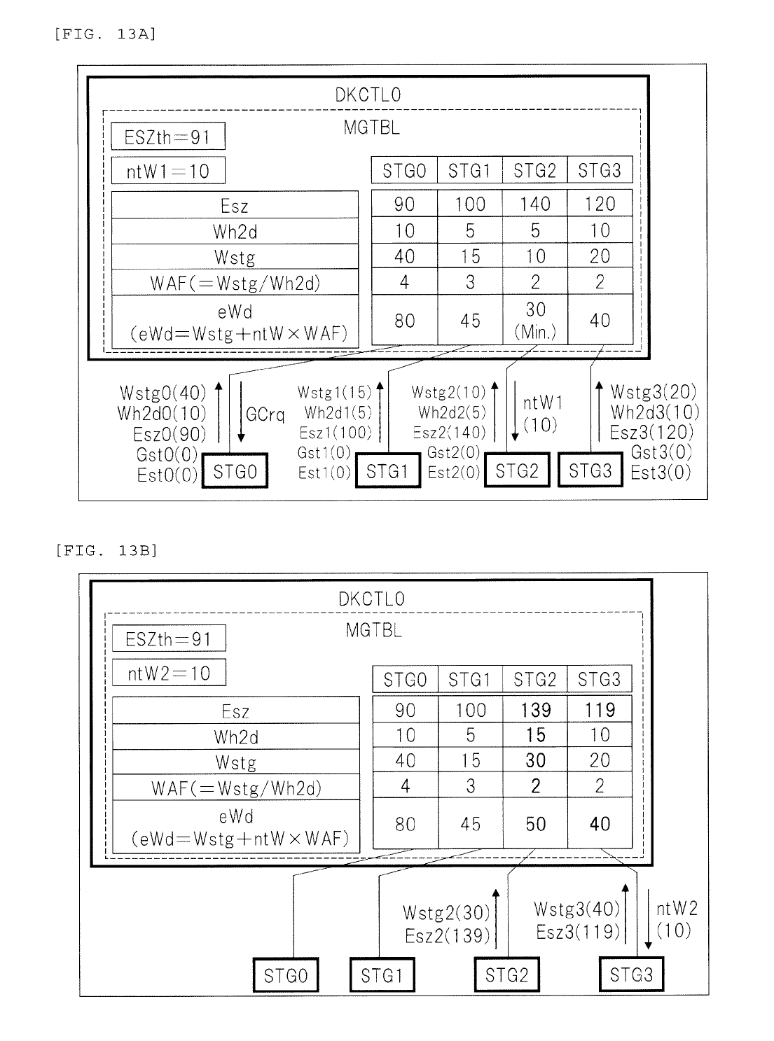

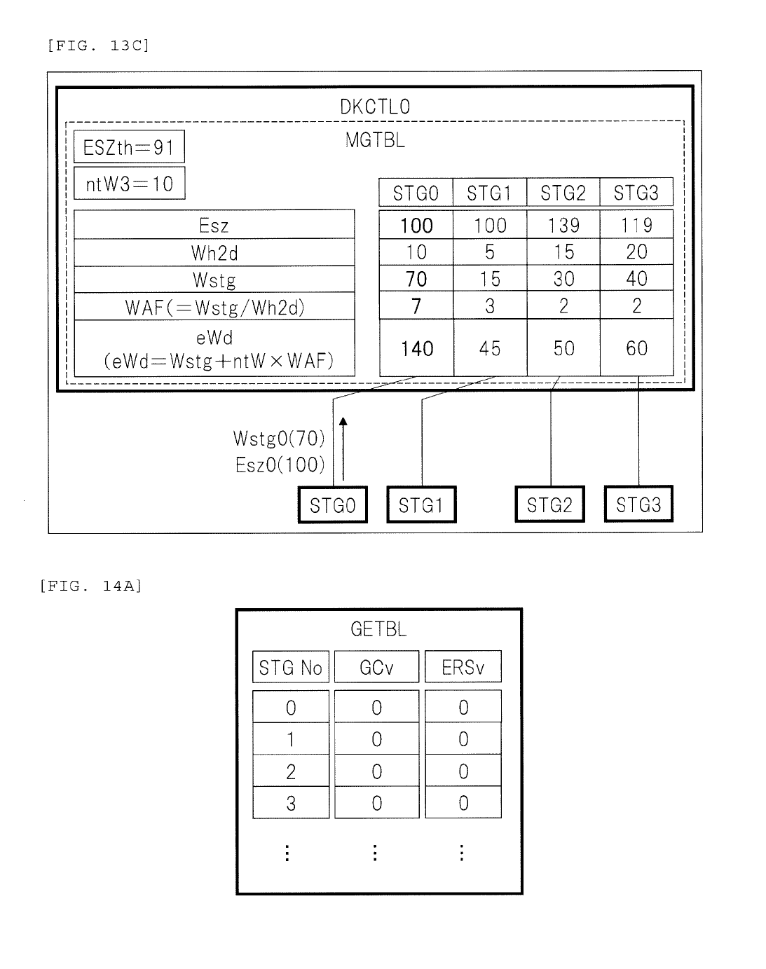

Hereinafter, the write operation executed by the write control circuit WTCTL in the control circuit DKCTL0 shown in FIG. 2 and the garbage collection request operation executed by the garbage collection control circuit GCCTL will be described with reference to FIGS. 5A and 5B as well as FIGS. 12 to 14, taking the case where the four storage modules STG0 to STG3 are provided, as an example, though this is not particularly limiting. FIG. 12 is a flowchart showing an example of the write operation and the garbage collection management operation performed by the storage module control circuit of FIGS. 1 and 2 in the storage device system according to Embodiment 3 of the invention. FIGS. 13A, 13B and 13C are supplementary diagrams of FIG. 12, showing an example of the content held in the table MGTBL held in the storage module control circuit DKCTL0 of FIG. 2. FIGS. 14A, 14B and 14C are supplementary diagrams of FIG. 12, showing an example of the content held in the table GETBL held in the storage module control circuit DKCTL0 of FIG. 2.

In the tables MGTBL shown in FIGS. 13A, 13B and 13C, the number of physical blocks in the erased state Esz for each of STG0 to STG3 is held, in addition to the data size ntW, and the data sizes Wh2d and Wstg, the write data size ratio WAF and the predicted write data size eWd for each of the storage modules STG0 to STG3, shown in FIG. 4 and the like. In the table GETBL shown in FIGS. 14A, 14B and 14C, the garbage collection execution state GCv and the erasure execution state ERSv for each of the storage modules STG0 to STG3 and the like having the respective numbers (STG No) are held. If GCv is it means that the garbage collection operation is being executed. If GCv is “0”, it means that the garbage collection operation is not being executed. If ERSv is “1”, it means that the erasure operation is being executed. If ERSv is “0”, it means that the erasure operation is not being executed.

In FIG. 12, first, the control circuit DKCTL0 issues a communication request for the number of physical blocks in the erased state Esz and the data sizes Wstg and Wh2d to the storage modules STG0 to STG3 via the interface signal H2D_IF, according to need (for example, immediately after the power to the storage controller STRGCONT is turned on, or the like). In response to this, the respective storage modules STG0 to STG3 send back the numbers of physical blocks in the erased state Esz (Esz0(90), Esz1(100), Esz2(140), Esz3(120)) to DKCTL0. The storage modules STG0 to STG3 also send back the data sizes Wstg (Wstg0(40), Wstg1(15), Wstg2(10), Wstg3(20)) and Wh2d (Wh2d0(10), Wh2d1(5), Wh2d2(5), Wh2d3(10)) to DKCTL0.

Moreover, the control circuit DKCTL0 issues a confirmation request about the garbage collection operation and the erasure operation to the storage modules STG0 to STG3 via the interface signal H2D_IF, according to need. In response to this, the respective storage modules STG0 to STG3 send back garbage collection statuses Gst (Gst0(0), Gst1(0), Gst2(0), Gst3(0)) and erasures statuses Est (Est0(0), Est1(0), Est2(0) Est3(0)) to DKCTL0 (FIG. 12, Step 1, and FIG. 13A).

Subsequently, the control circuit DKCTL0 sets these numbers of physical blocks in the erased state Esz and data sizes Wstg and Wh2d in the table MGTBL and thus updates MGTBL. Moreover, DKCTL0 sets these garbage collection statuses Gst and erasure statuses Est in the garbage collection execution state GCv and the erasure execution state ERSv in the table GETBL and thus updates GETBL (FIG. 12, Step 2, and FIGS. 13A and 14A).

Here, it is assumed that DKCTL0 currently takes a write access request (write command) (WREQ[1]) including write data (WDT[1]) with a data size ntW1 (here, 10) and a logical address (here, 123), as a processing target. In this case, the write control circuit WTCTL in DKCTL0 finds the write data size ratio WAF for each of STG0 to STG3, using Wstg and Wh2d in MGTBL, and also finds the predicted write data size eWd, using ntW1, and sets these in MGTBL and thus updates MGTBL (FIG. 12, Step 3, and FIG. 13A). In the example of FIG. 13A, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=30, and eWd3=40, respectively.

Next, the garbage collection control circuit GCCTL reads out the table GETBL (FIG. 14A) and selects the storage modules STG0 to STG4, in which the garbage collection operation or the erasure operation is not currently being performed, as garbage collection target storage modules (FIG. 12, Step 4, and FIG. 13A). Then, GCCTL compares the number of physical blocks in the erased state Esz (Esz0(90), Est1(100), Esz2(140), Esz3(120)) for each of the storage modules STG0 to STG3 selected in Step 4, with a preset threshold ESZth of the number of physical blocks in the erased state (here, 91). Then, GCCTL selects the storage module (here, STG0) having a smaller number of physical blocks Esz than the threshold ESZth (=91) of the number of physical blocks in the erased state, as a garbage collection target storage module. Moreover, GCCTL selects the storage modules STG1 to STG3 having a number of physical blocks Esz that is equal to or greater than the threshold ESZth (=91) of the number of physical blocks in the erased state, as write and read target storage modules (FIG. 12, Step 5, and FIG. 13A).

Subsequently, the garbage collection control circuit GCCTL issues a garbage collection request (GCrq) to the storage module STG0 selected as a garbage collection target in Step 5, and updates the table GETBL. That is, as shown in FIG. 14B, the value of the garbage collection execution state GCv corresponding to the storage module number (STG No) of “0” becomes “1”, and this shows that the storage module STG0 is executing the garbage collection operation (FIG. 12, Step 11, and FIGS. 13A and 14B).

Here, having received the garbage collection request (GCrq), the storage module STG0 executes garbage collection, using the processing of Steps 3 to 8 of FIG. 8. That is, in FIG. 8, by the processing of Steps 1 and 2, the storage module itself determines whether to execute the garbage collection operation or not, whereas in the flow of FIG. 12, the garbage collection control circuit GCCTL in the control circuit DKCTL0 situated at an upper position than the storage module determines this, instead of the storage module itself. Thus, DKCTL0 can issue a write access request (WREQ) or read access request (RREQ), targeting the storage modules in which the garbage collection operation is not being executed. Therefore, it is possible to increase the efficiency of the write operation and read operation or the like.

Subsequently, the write control circuit WTCTL selects the storage module (here, STG2) in which the predicted write data size eWd is the smallest value (Min.), from among the storage modules selected as write and read target storage modules in Step 5 (FIG. 12, Step 6, and FIG. 13A). Next, if the data size Wstg is communicated from the storage modules STG0 to STG3, the processing goes to Step 2 and Steps 2 to 6 are executed again. Meanwhile, if Wstg is not communicated from STG0 to STG3, the processing goes to Step 8 (FIG. 12, Step 7).

In Step 8, the write control circuit WTCTL issues a write access request (write command) (WREQ[1]) including write data (WDT[1]) with a data size ntW1 (=10) and a logical address LAD (=123), to the storage module STG2 selected in Step 6 (FIG. 13A). Next, WTCTL updates the table STGTBL on the basis of the correspondence between this LAD (=123) and STG2 (FIG. 12, Step 9, and FIG. 5A), and also updates the data size Wh2d in the table MGTBL (FIG. 12, Step 9, and FIG. 13B). That is, at LAD (=123) in STGTBL of FIG. 5A, the storage module number (STG No) is updated to “2” and the validity information VLD is updated to “1”. Also, at STG2 in MGTBL of FIG. 13B, Wh2d is updated from “5” to “15”.

Then, as the storage module STG2 completes writing of the write data (WDT[1]), the storage module STG2 communicates the number of physical blocks in the erased state Esz (Esz2(139)) and the data size Wstg (Wstg2(30)) to the control circuit DKCTL0 (FIG. 12, Step 10, and FIG. 13B), and returns to Step 2. In this example, in STG2, for example, the data size “20” is written through a static wear leveling operation or the like during a period before writing the write data (WDT[1]) with the data size ntW1(=10). Therefore, a total value of “30” is communicated as Wstg2. Also, in STG2, with the writing in response to the write access request (write command) (WREQ[1]), the number of physical blocks in the erased state Esz (=140) in FIG. 13A is reduced to the number of physical blocks in the erased state Esz (=139) in FIG. 13B.

Subsequently, the write control circuit WTCTL sets the communicated number of physical blocks in the erased state Esz (=139) and data size Wstg (Wstg2 (30)) in the table MGTBL and thus updates MGTBL (FIG. 12, Step 2, and FIG. 13B). Here, it is assumed that DKCTL0 currently takes a write access request (write command) (WREQ[2]) including write data (WDT[2]) with a data size ntW2 (here, 10) and a logical address (here, 535), as a processing target. In this case, WTCTL finds the write data size ratio WAF for each of the storage modules STG0 to STG3, using the data sizes Wstg and Wh2d in MGTBL, and also finds the predicted write data size eWd, using ntW2, and sets these in MGTBL and thus updates MGTBL (FIG. 12, Step 3, and FIG. 13B). In the example of FIG. 13B, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=50, and eWd3=40, respectively.

Next, the garbage collection control circuit GCCTL reads out the table GETBL (FIG. 14B) and selects the storage modules STG1 to STG3, in which the garbage collection operation or the erasure operation is not currently being carried out, as garbage collection target storage modules (FIG. 12, Step 4, and FIG. 13B). Then, GCCTL compares the number of physical blocks in the erased state Esz (Esz1(100), Esz2(140), Esz3(120)) for each of the storage modules STG1 to STG3 selected in Step 4, with a preset threshold ESZth(=91) of the number of physical blocks in the erased state. Here, there is no storage module having a smaller number of physical blocks Esz than the threshold ESZth (=91) of the number of physical blocks in the erased state. Thus, GCCTL selects the storage modules STG1 to STG3 as write and read target storage modules (FIG. 12, Step 5, and FIG. 13B).

Subsequently, the write control circuit WTCTL selects the storage module (here, STG3) in which the predicted write data size eWd is the smallest value (Min.), from among the write and read target storage modules selected in Step 5 (FIG. 12, Step 6, and FIG. 13E). Next, if the data size Wstg is communicated from the storage modules STG0 to STG3, the processing goes to Step 2 and Steps 2 to 6 are executed again. Meanwhile, if Wstg is not communicated from STG0 to STG3, the processing goes to Step 8 (FIG. 12, Step 7).

In Step 8, the write control circuit WTCTL in the control circuit DKCTL0 issues a write access request (write command) (WREQ[2]) including write data (WDT[2]) with a data size ntW2 (=10) and a logical address LAD (=535), to the storage module STG3 selected in Step 6 (FIG. 13B). Next, WTCTL updates the table STGTBL on the basis of the correspondence between this LAD (=535) and STG3 (FIG. 12, Step 9, and FIG. 5B), and also updates the data size Wh2d in the table MGTBL (FIG. 12, Step 9, and FIG. 13C). That is, at LAD (=535) in STGTBL of FIG. 5B, the storage module number (STG No) is updated to “3” and the validity information VLD is updated to “1”. Also, at STG3 in MGTBL of FIG. 13C, Wh2d is updated from “10” to “20”.

Then, as the storage module STG3 completes writing of the write data (WDT[2]), STG3 communicates the number of physical blocks in the erased state Esz (Esz3(119)) and the data size Wstg (Wstg3(40)) to the control circuit DKCTL0 (FIG. 12, Step 10), and the processing goes to Step 2. In Step 8, at the storage modules to which a write access request (WREQ) is issued (here, STG2, STG3), the logical address LAD included in this write access request (WREQ) is converted to a physical address (PAD) in the non-volatile memories NVM0 to NVM7 and the write data is written at this converted physical address (PAD).

Now, the case where the storage STG0, having received the garbage collection request (GCrq) in Step 11, as described above, completes the garbage collection operation after the completion of the write operation of the write data (WDT[2]) by the storage modules STG3, will be described. On completion of the garbage collection operation, the storage module STG0 transmits the number of physical blocks in the erased state Esz (Esz0(100)) and the data size Wstg (Wstg0(70)) after this garbage collection operation, to the control circuit DKCTL0 (FIG. 12, Step 12, and FIG. 130).

In response to the completion of the garbage collection operation, the garbage collection control circuit GCCTL in the control circuit DKCTL0 updates the table GETBL. That is, as shown in FIG. 14A, the value of the garbage collection execution state GCv corresponding to the storage module number (STG No) of “0” becomes “0”, and this shows that the storage module STG0 is not executing the garbage collection operation.

Also, the write control circuit WTCTL in the control circuit DKCTL0 sets the number of physical blocks in the erased state Esz (Esz0(100)) and the data size Wstg (Wstg0(70)) in the table MGTBL and thus updates MGTBL (FIG. 12, Step 2, and FIG. 13C). Next, WTCTL finds the write data size ratio WAF and the predicted write data size eWd of the storage module STG0, using the data sizes Wstg and Wh2d of the storage module STG0, and sets these in the table MGTBL and thus updates MGTBL (FIG. 12, Step 3, and FIG. 13C). In FIG. 13C, WAF=7 is given, and if the data size ntW3 involved in the next write access request (write command) (WREQ) is “10”, eWd0=140 holds.

As described above, by using the storage device system of this Embodiment 3, typically, it is possible to realize the leveling of the number of erasures (and consequently the leveling of the number of writes) in the storage device system as a whole, and to realize improved reliability and a longer life or the like, as in the case of Embodiment 1. Moreover, since the storage controller STRGCONT manages the garbage collection operation, it is possible to grasp which storage module is executing the garbage collection operation and which storage module is capable of writing and reading, and therefore to execute the garbage collection operation and the write and read operation simultaneously. Consequently, a higher speed or the like of the storage system can be achieved while the leveling is performed.

### Embodiment 4

In this Embodiment 4, the case where the storage module control circuit DKCTL0 performs the erasure operation in addition to the execution of the writing operation (the wear leveling among the storage modules) according to Embodiment 1 described with reference to FIGS. 3, 4A and 4B or the like, will be described.

### Wear Leveling Among Storage Modules+Erasure Operation

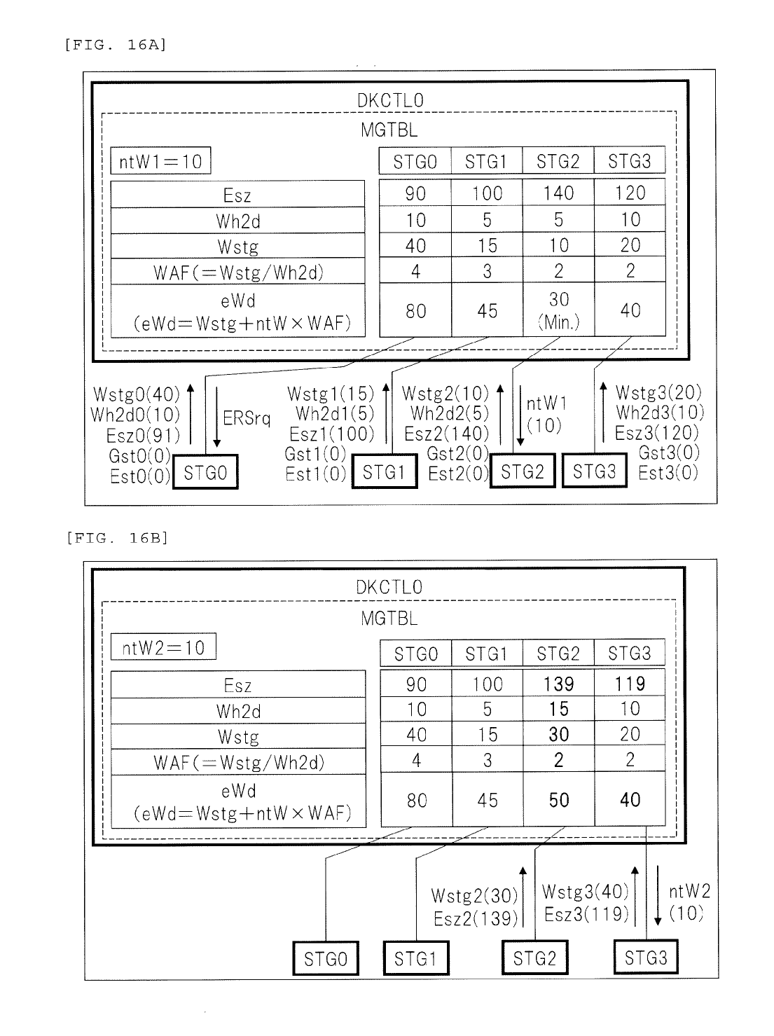

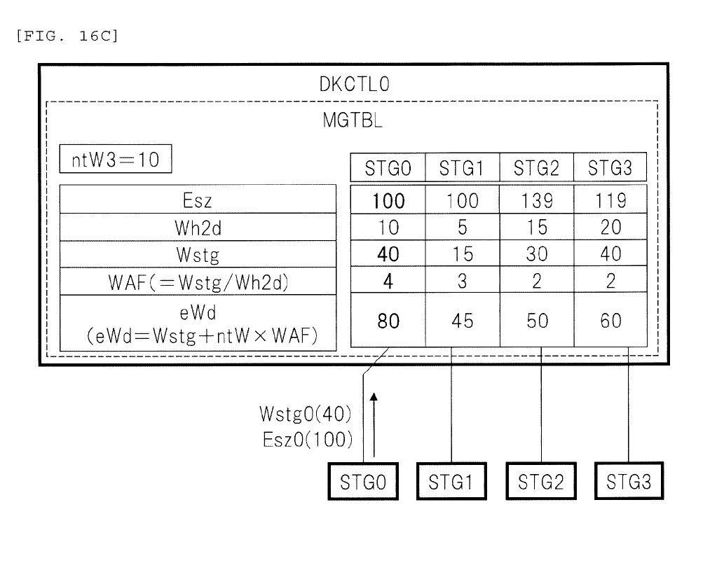

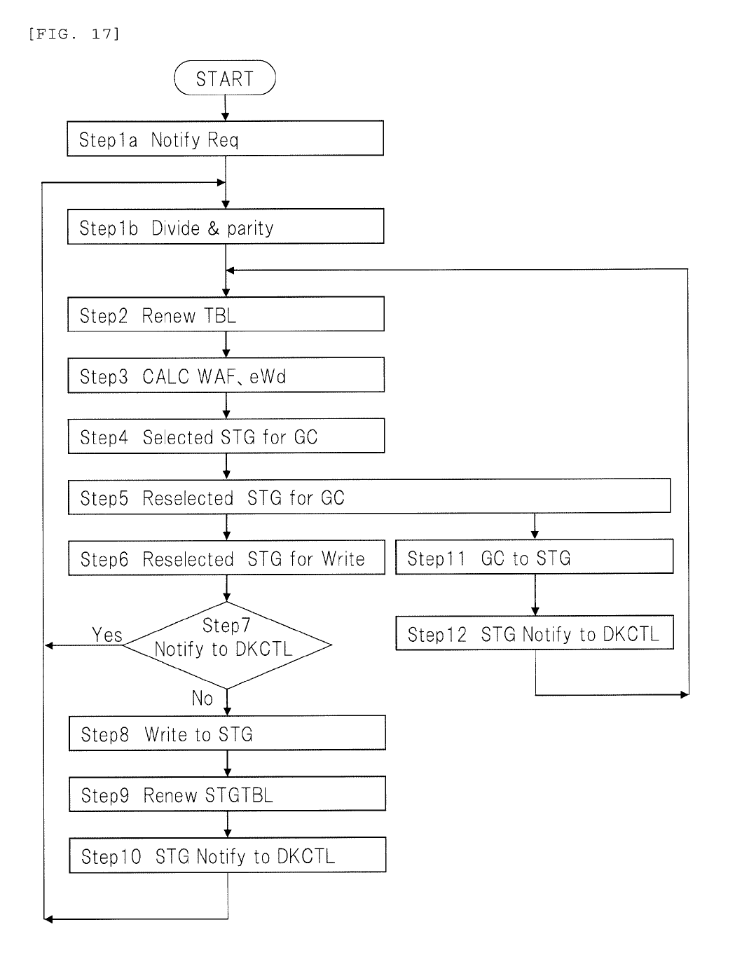

Hereinafter, the write operation executed by the write control circuit WTCTL in the control circuit DKCTL0 shown in FIG. 2 and the erasure request operation executed by the data erasure control circuit ERSCTL will be described with reference to FIGS. 5C, 5D, 14A and 14C as well as FIGS. 15 and 16, taking the case where the four storage modules STG0 to STG3 are provided, as an example, though this is not particularly limiting. FIG. 15 is a flowchart showing an example of the write operation and the erasure operation performed by the storage module control circuit of FIGS. 1 and 2 in the storage device system according to Embodiment 4 of the invention. FIGS. 16A, 16B and 16C are supplementary diagrams of FIG. 15, showing an example of the content held in the table MGTBL held in the storage module control circuit DKCTL0 of FIG. 2.

In FIG. 15, first, the control circuit DKCTL0 issues a communication request for the number of physical blocks in the erased state Esz and the data sizes Wstg and Wh2d to the storage modules STG0 to STG3 via the interface signal H2D_IF, according to need (for example, immediately after the power to the storage controller STRGCONT is turned on, or the like). In response to this, the respective storage modules STG0 to STG3 send back the numbers of physical blocks in the erased state Esz (Esz0(90), Esz1(100), Esz2(140), Esz3(120)) to DKCTL0. The storage modules STG0 to STG3 also send back the data sizes Wstg (Wstg0(40), Wstg1(15), Wstg2(10), Wstg3(20)) and Wh2d (Wh2d0(10), Wh2d1(5), Wh2d2(5), Wh2d3(10)) to DKCTL0.

Moreover, the control circuit DKCTL0 issues a confirmation request about the garbage collection operation and the erasure operation to the storage modules STG0 to STG3 via the interface signal H2D_IF, according to need. In response to this, the respective storage modules STG0 to STG3 send back garbage collection statuses Gst (Gst0(0), Gst1(0), Gst2(0), Gst3(0)) and erasures statuses Est (Est0(0), Est1(0), Est2(0), Est3(0)) to DKCTL0 (FIG. 15, Step 1, and FIG. 16A).

Subsequently, the control circuit DKCTL0 sets these numbers of physical blocks in the erased state Esz and data sizes Wstg and Wh2d in the table MGTBL and thus updates MGTBL. Moreover, DKCTL0 sets these garbage collection statuses Gst and erasure statuses Est in the garbage collection execution state GCv and the erasure execution state ERSv in the table GETBL and thus updates GETBL (FIG. 15, Step 2, and FIGS. 16A and 14A).

Here, it is assumed that DKCTL0 currently takes a write access request (write command) (WREQ[1]) including write data (WDT[1]) with a data size ntW1 (here, 10) and a logical address (here, 123), as a processing target. In this case, the write control circuit WTCTL in DKCTL0 finds the write data size ratio WAF for each of STG0 to STG3, using Wstg and Wh2d in MGTBL, and also finds the predicted write data size eWd, using ntW1, and sets these in MGTBL and thus updates MGTBL (FIG. 15, Step 3, and FIG. 16A). In the example of FIG. 16A, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=30, and eWd3=40, respectively.

In the subsequent Step 4, though not particularly limiting, the storage controller STRGCONT checks whether there is a data erasure request (EQ) from the information processing devices SRV0 to SRVm. If there is a data erasure request (EQ), Step 5 is executed. If not, Step 6 is executed. That is, for example, a data erasure request (EQ) for erasing data of the logical addresses LAD “1000 to 2279” is inputted to the interface circuits of STRGCONT STIF00 to STIFm1, from SRV0 to SRVm. This data erasure request (EQ) is communicated to the data erasure control circuit ERSCTL of the control circuit DKCTL0 via the control circuit HCTL0 (FIG. 15, Step 4), and then Step 5 is executed.

Next, the data erasure control circuit ERSCTL searches the table STGTBL shown in FIG. 5C for the logical addresses LAD=1000 to 2279, and grasps that all the data of the logical addresses LAD=1000 to 2279 are saved in the storage module STG0. Moreover ERSCTL reads out the table GETBL (FIG. 14A) and selects the storage module STG0, in which the garbage collection operation and the erasure operation are not currently being performed, as an erasure operation target storage module (FIG. 15, Step 5, and FIG. 16A).

Subsequently, the data erasure control circuit ERSCTL issues a data erasure access request (ERSrq) for erasing the data of the logical addresses LAD=1000 to 2279, to the storage module STG0, and updates the table GETBL. That is, as shown in FIG. 14C, the value of the erasure execution state ERSv corresponding to the storage module number (STG No) of “0” becomes “1”, and this shows that STG0 is executing the erasure operation (FIG. 15, Step 11, and FIGS. 16A and 14C).

Next, the write control circuit WTCTL selects the storage module (here, STG2) in which the predicted write data size eWd is the smallest value (Min.), from among the other storage modules STG1 to STG3 than the erasure operation target in Step 5, (FIG. 15, Step 6, and FIG. 16A). Next, if the data size Wstg is communicated from the storage modules STG0 to STG3, the processing goes to Step 2, and Steps 2 to 4 and Step 6 are executed again. Meanwhile, if Wstg is not communicated from STG0 to STG3, the processing goes to Step 8 (FIG. 15, Step 7).

In Step 8, the write control circuit WTCTL issues a write access request (write command) (WREQ[1]) including write data (WDT[1]) with a data size ntW1 (=10) and a logical address LAD (=123), to the storage module STG2 selected in Step 6 (FIG. 16A). Next, WTCTL updates the table STGTBL on the basis of the correspondence between this LAD (=123) and STG2 (FIG. 15, Step 9, and FIG. 5A), and also updates the data size Wh2d in the table MGTBL (FIG. 15, Step 9, and FIG. 16B). That is, at LAD (=123) in STGTBL of FIG. 5A, the storage module number (STG No) is updated to “2” and the validity information VLD is updated to “1”. Also, at STG2 in MGTBL of FIG. 16B, Wh2d is updated from “5” to “15”.

Then, as the storage module STG2 completes writing of the write data (WDT[1]), the storage module STG2 communicates the number of physical blocks in the erased state Esz (Esz2(139)) and the data size Wstg (Wstg2(30)) to the control circuit DKCTL0 (FIG. 15, Step 10, and FIG. 16B), and returns to Step 2. In this example, in STG2, for example, the data size “20” is written through a static wear leveling operation or the like during a period before writing the write data (WDT[1]) with the data size ntW1(=10). Therefore, a total value of “30” is communicated as Wstg2. Also, in STG2, with the writing in response to the write access request (write command) (WREQ[ 1]), the number of physical blocks in the erased state Esz (=140) in FIG. 16A is reduced to the number of physical blocks in the erased state Esz (=139) in FIG. 16B.

Subsequently, the write control circuit WTCTL sets the communicated number of physical blocks in the erased state Esz (=139) and data size Wstg (Wstg2(30)) in the table MGTBL and thus updates MGTBL (FIG. 15, Step 2, and FIG. 16B). Here, it is assumed that DKCTL0 currently takes a write access request (write command) (WREQ[2]) including write data (WDT[2]) with a data size ntW2 (here, 10) and a logical address (here, 535), as a processing target. In this case, WTCTL finds the write data size ratio WAF for each of the storage modules STG0 to STG3, using the data sizes Wstg and Wh2d in MGTBL, and also finds the predicted write data size eWd, using ntW2, and sets these in MGTBL and thus updates MOTEL (FIG. 15, Step 3, and FIG. 16D). In the example of FIG. 16B, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=50, and eWd3=40, respectively.

In the subsequent Step 4, the storage controller STRGCONT checks whether there is a data erasure request (EQ) from the information processing devices SRV0 to SRVm, and STRGCONT executes Step 5 if there is a data erasure request (EQ), and executes Step 6 if not, though this is not particularly limiting. In this case, since there is no data erasure request (EQ), Step 6 is executed. Subsequently, the write control circuit WTCTL selects the storage module (here, STG3) in which the predicted write data size eWd is the smallest value (Min.), from among the other storage modules STG1 to STG3 than the erasure operation target in Step 5 (FIG. 15, Step 6, and FIG. 16B). Next, if the data size Wstg is communicated from the storage modules STG0 to STG3, the processing goes to Step 2 and Steps 2 to 4 and Step 6 are executed again. Meanwhile, if Wstg is not communicated from STG0 to STG3, the processing goes to Step 8 (FIG. 15, Step 7).

In Step 8, the write control circuit WTCTL in the control circuit DKCTL0 issues a write access request (write command) (WREQ[2]) including write data (WDT[2]) with a data size ntW2 (=10) and a logical address LAD (=535), to the storage module STG3 selected in Step 6 (FIG. 16B). Next, WTCTL updates the table STGTBL on the basis of the correspondence between this LAD (=535) and STG3 (FIG. 15, Step 9, and FIG. 5B), and also updates the data size Wh2d in the table MGTBL (FIG. 12, Step 9, and FIG. 16C). That is, at LAD (=535) in STGTBL of FIG. 5B, the storage module number (STG No) is updated to “3” and the validity information VLD is updated to “1”. Also, at STG3 in MGTBL of FIG. 16C, Wh2d is updated from “10” to “20”.

Then, as the storage module STG3 completes writing of the write data (WDT[2]), STG3 communicates the number of physical blocks in the erased state Esz (Esz3(119)) and the data size Wstg (Wstg3(40)) to the control circuit DKCTL0 (FIG. 15, Step 10), and the processing goes to Step 2. In Step 8, at the storage modules to which a write access request (WREQ) is issued (here, STG2, STG3), the logical address LAD included in this write access request (WREQ) is converted to a physical address (PAD) in the non-volatile memories NVM0 to NVM7 and the write data is written at this converted physical address (PAD).

Now, the case where the storage module STG0, having received the data erasure access request (ERSrq) in Step 11, as described above, completes the erasure operation after the completion of the write operation of the write data (WDT[2]) by the storage modules STG3, will be described. On completion of the erasure operation, the storage module STG0 transmits the number of physical blocks in the erased state Esz (Esz0(100)) and the data size Wstg (Wstg0(70)) after this erasure operation, to the control circuit DKCTL0 (FIG. 15, Step 12, and FIG. 16C).

In response to the completion of the erasure operation, the data erasure control circuit ERSCTL in the control circuit DKCTL0 updates the table GETBL. That is, as shown in FIG. 14A, the value of the erasure execution state ERSv corresponding to the storage module number (STG No) of “0” becomes “0”, and this shows that the storage module STG0 is not executing the erasure operation.

Also, the write control circuit WTCTL in the control circuit DKCTL0 sets the number of physical blocks in the erased state Esz (Esz0(100)) and the data size Wstg (Wstg0(40)) in the table MGTBL and thus updates MGTBL (FIG. 15, Step 2, and FIG. 16C). Next, WTCTL finds the write data size ratio WAF and the predicted write data size eWd of the storage module STG0, using the data sizes Wstg and Wh2d of the storage module STG0, and sets these in the table MGTBL and thus updates MGTBL (FIG. 15, Step 3, and FIG. 16C). In FIG. 16C, WAF=4 remains as it is, and if the data size ntW3 involved in the next write access request (write command) (WREQ) is “10”, eWd0=80 holds.

As described above, by using the storage device system of this Embodiment 4, typically, it is possible to realize the leveling of the number of erasures (and consequently the leveling of the number of writes) in the storage device system as a whole, and to realize improved reliability and a longer life or the like, as in the case of Embodiment 1. Moreover, since the storage controller STRGCONT controls the erasure operation, it is possible to grasp which storage module is executing the erasure operation and which storage module is capable of writing and reading, and therefore to execute the erasure operation and the write and read operation simultaneously. Consequently, a higher speed or the like of the storage system can be achieved while the leveling is performed.

In this Embodiment 4 and the above Embodiment 3, examples in which the storage controller STRGCONT performs the management of the garbage collection operation and the control of the erasure operation, targeting each storage module STG, are described. Similarly to this, the storage control circuit STCT0 of FIG. 6 may perform the management of the garbage collection operation and the control of the erasure operation, targeting the respective non-volatile memories NVM0 to NVM7. That is, information (GCnvm) indicating in which one of NVM0 to NVM7 the garbage collection operation is being performed, and information (ERSnvm) in which one of NVM0 to NVM7 the erasure operation is being performed, or the like may be included in the random access memory RAMst of FIG. 6. Thus, similar effects to the case of the storage controller can be achieved.

### Embodiment 5

In this Embodiment 5, the case where the storage system STRGSYS of FIG. 1 has a RAID function (for example, RAID 5 or the like) will be described. Then, on the assumption of this RAID function, the case where the storage module control circuit DKCTL0 performs the write operation (wear leveling among the storage modules) and the management of the garbage collection according to Embodiment 3 described with reference to FIGS. 12, 13A, 13B and 13C or the like, will be described.

Wear Leveling Among Storage Modules+Garbage Collection Management when RAID is Applied

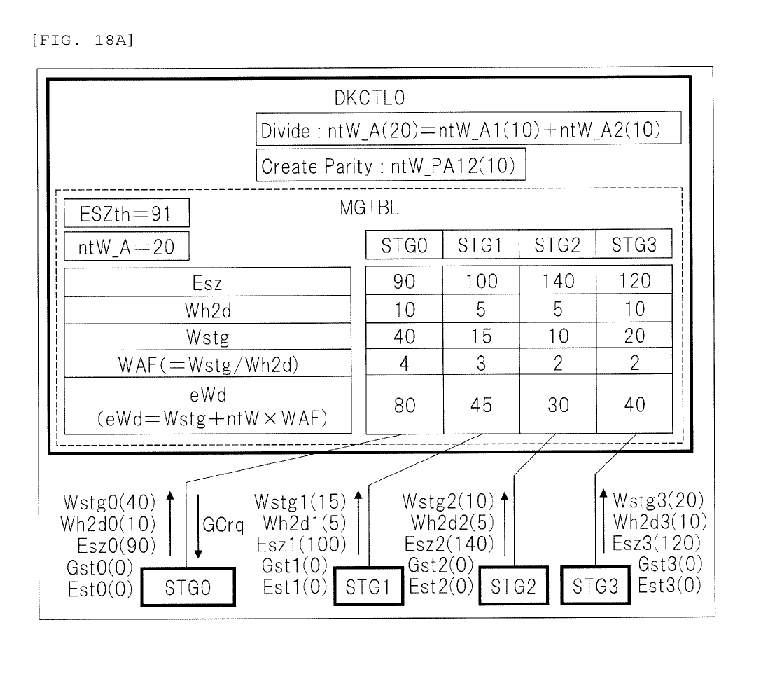

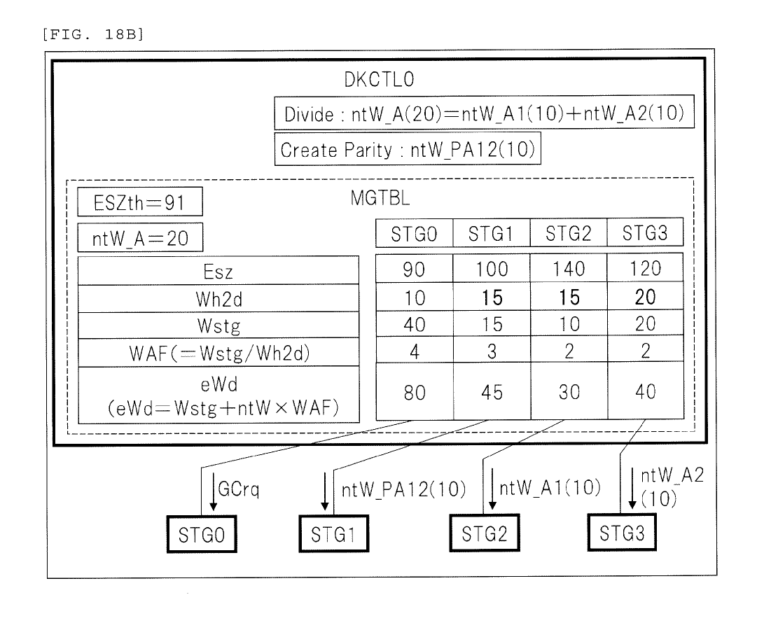

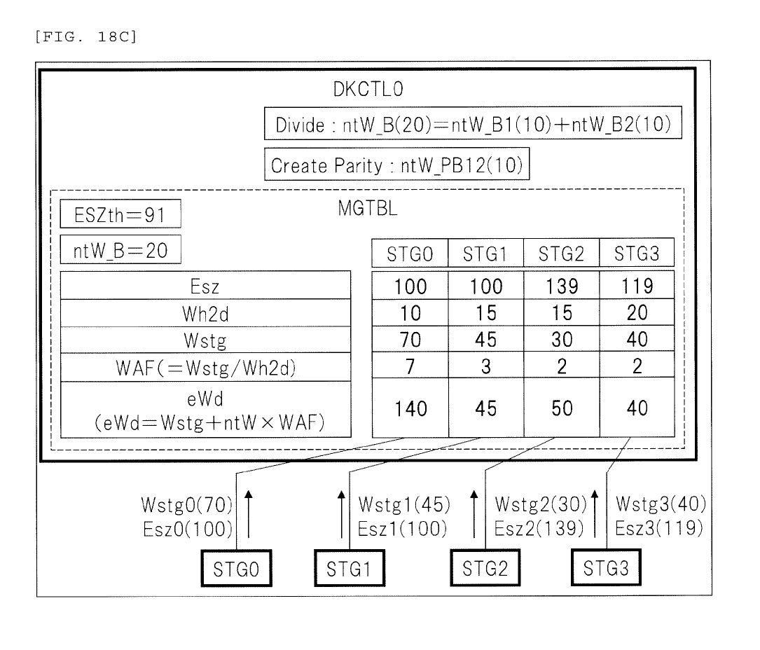

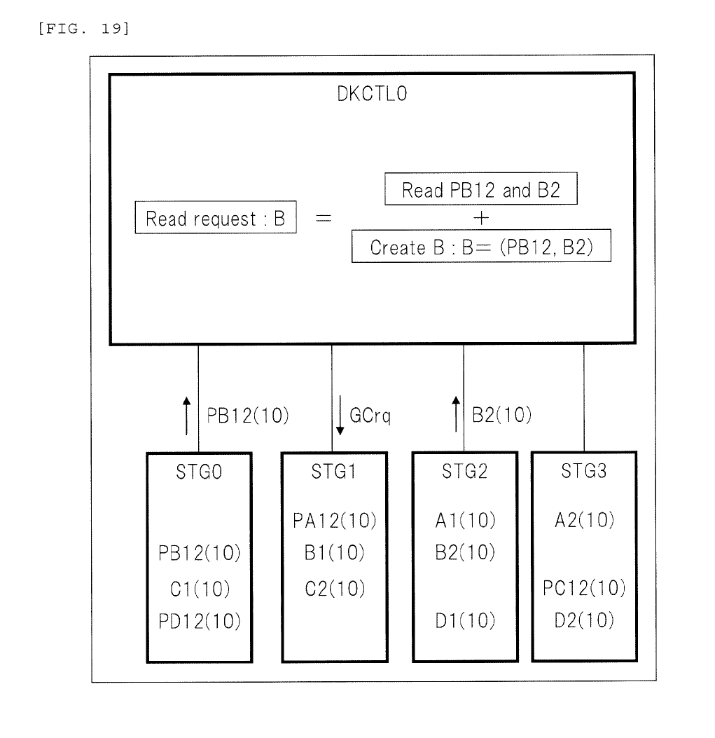

Hereinafter, the case where the four storage modules STG0 to STG3 are provided will be described as an example, though this is not particularly limiting. Then, with respect to this case, the write operation executed by the write control circuit WTCTL in the control circuit DKCTL0 shown in FIG. 2 and the garbage collection request operation executed by the garbage collection control circuit GCCTL will be described with reference to FIGS. 14A and 14B as well as FIGS. 17 and 18. FIG. 17 is a flowchart showing an example of the write operation and the garbage collection management operation performed by the storage module control circuit of FIGS. 1 and 2 in the storage device system according to Embodiment 5 of the invention. FIGS. 18A, 18B and 18C are supplementary diagrams of FIG. 17, showing an example of the content held in the table MGTBL held in the storage module control circuit DKCTL0 of FIG. 2.

In Step 1a of FIG. 17, the control circuit DKCTL0 issues a communication request for the number of physical blocks in the erased state Esz and the data sizes Wstg and Wh2d to the storage modules STG0 to STG3 via the interface signal H2D_IF, according to need (for example, immediately after the power to the storage controller STRGCONT is turned on, or the like). In response to this, the respective storage modules STG0 to STG3 send back the numbers of physical blocks in the erased state Esz (Esz0(90), Esz1(100), Esz2(140), Esz3(120)) to DKCTL0. The storage modules STG0 to STG3 also send back the data sizes Wstg (Wstg0(40), Wstg1(15), Wstg2(10), Wstg3(20)) and Wh2d (Wh2d0(10), Wh2d1(5), Wh2d2(5), Wh2d3(10)) to DKCTL0 (FIG. 18A).

Moreover, in Step 1b of FIG. 17, the control circuit DKCTL0 issues a confirmation request about the garbage collection operation and the erasure operation to the storage modules STG0 to STG3 via the interface signal H2D_IF, according to need. In response to this, the respective storage modules STG0 to STG3 send back garbage collection statuses Gst (Gst0(0), Gst1(0), Gst2(0), Gst3(0)) and erasures statuses Est (Est0(0), Est1(0), Est2(0), Est3(0)) to DKCTL0 (FIG. 18A).

Subsequently, in Step 1b of FIG. 17, the write control circuit WTCTL first divides write data (WDT[A]) with a data size ntW_A (here, 20) held in the random access memories RAM0 to RAM3. In this example, the write data is divided into write data (WDT[A1]) with a data size ntW_A1 (here, 10) and write data (WDT[A2]) with a data size ntW_A2 (here, 10). Next, WTCTL generates parity data (PA12) with a data size ntW_PA12 (here, 10) from the divided write data (WDT[A1]) and write data (WDT[A2]) (FIG. 18A). Then, WTCTL generates a write access request (WREQ[A1]) including WDT[A1] with a data size ntW_A1 (=10) and a predetermined logical address (here, 223), and a write access request (WREQ[A2]) including WDT[A2] with a data size ntW_A2 (=10) and a predetermined logical address (here, 224). In addition, WTCTL generates a write access request (WREQ[PA12]) including PA12 with a data size ntW_PA12 (=10) and a predetermined logical address (here, 225).

Next, the control circuit DKCTL0 sets the numbers of physical blocks in the erased state Esz and the data sizes Wstg and Wh2d involved in Step 1a, in the table MGTBL and thus updates MGTBL. Moreover, DKCTL0 sets the garbage collection statuses Gst and the erasure statuses Est involved in Step 1a, in the garbage collection execution state GCv and the erasure execution state ERSv in the table GETBL and thus updates GETBL (FIG. 17, Step 2, and FIGS. 18A and 14A).

Subsequently, the write control circuit WTCTL in DKCTL0 finds the write data size ratio WAF for each of STG0 to STG3, using Wstg and Wh2d in MGTBL. WTCTL also finds the predicted write data size eWd, using the data size ntW_A1=ntW_A2=ntW_PA12=10, and sets these in MGTBL and thus updates MGTBL (FIG. 17, Step 3, and FIG. 18A). In the example of FIG. 18A, WAF (=Wstg/Wh2d) for STG0, STG1, STG2, and STG3 is WAF0=4, WAF1=3, WAF2=2, and WAF3=2, respectively. Meanwhile, eWd (=Wstg+ntW×WAF) for STG0, STG1, STG2, and STG3 is eWd0=80, eWd1=45, eWd2=30, and eWd3=40, respectively.

Next, the garbage collection control circuit GCCTL reads out the table GETBL (FIG. 14A) and selects the storage modules STG0 to STG4, in which the garbage collection operation or the erasure operation is not currently being performed, as garbage collection target storage modules (FIG. 17, Step 4, and FIG. 18A). Then, GCCTL compares the number of physical blocks in the erased state Esz (Esz0(90), Est1(100), Esz2(140), Esz3(120)) for each of the storage modules STG0 to STG3 selected in Step 4, with a preset threshold ESZth of the number of physical blocks in the erased state (here, 91). Then, GCCTL selects the storage module (here, STG0) having a smaller number of physical blocks Esz than the threshold ESZth (=91) of the number of physical blocks in the erased state, as a garbage collection target storage module. Moreover, GCCTL selects the storage modules STG1 to STG3 having a number of physical blocks Esz that is equal to or greater than the threshold ESZth (=91) of the number of physical blocks in the erased state, as write and read target storage modules (FIG. 17, Step 5, and FIG. 18A).

Subsequently, the garbage collection control circuit GCCTL issues a garbage collection request (GCrq) to the storage module STG0 selected as a garbage collection target in Step 5, and updates the table GETBL. That is, as shown in FIG. 14B, the value of the garbage collection execution state GCv corresponding to the storage module number (STG No) of “0” becomes “1”, and this shows that the storage module STG0 is executing the garbage collection operation (FIG. 17, Step 11, and FIGS. 18A and 14B).

Here, having received the garbage collection request (GCrq), the storage module STG0 executes garbage collection, using the processing of Steps 3 to 8 of FIG. 8. That is, in FIG. 8, by the processing of Steps 1 and 2, the storage module itself determines whether to execute the garbage collection operation or not, whereas in the flow of FIG. 17, the garbage collection control circuit GCCTL in the control circuit DKCTL0 situated at an upper position than the storage module determines this, instead of the storage module itself. Thus, DKCTL0 can issue a write access request (WREQ) or a read access request (RREQ), targeting the storage modules in which the garbage collection operation is not being executed. Therefore, it is possible to increase the efficiency of the write operation and read operation or the like.

Subsequently, the write control circuit WTCTL selects three storage modules (here, STG2, STG3, STG1) in order of the smallest predicted write data size eWd, from among the storage modules selected as write and read target storage modules in Step 5 (FIG. 17, Step 6, and FIG. 18A). Next, if the data size Wstg is communicated from the storage modules STG0 to STG3, the processing goes to Step 2 and Steps 2 to 6 are executed again. Meanwhile, if Wstg is not communicated from STG0 to STG3, the processing goes to Step 8 (FIG. 17, Step 7).

In Step 8, the write control circuit WTCTL issues write access requests (write commands) (WREQ[A1], WREQ[A2], WREQ[PA12]) respectively to the storage modules STG2, STG3, and STG1 selected in Step 6 (FIG. 18B). Next, WTCTL updates the table STGTBL on the basis of the correspondence between the logical addresses LAD (223, 224, 225) involved in the respective write access requests, and STG2, STG3, STG1 (FIG. 17, Step 9), and also updates the data size Wh2d in the table MGTBL (FIG. 17, Step 9, and FIG. 18B). That is, in STGTBL as shown in FIG. 5A, though not illustrated, the storage module number (STG No) at LAD (=223) is updated to “2” and the validity information VLD is updated to “1”. Also, STG No at LAD (=224) is updated to “3” and VLD is updated to “1”. STG No at LAD (=225) is updated to “1” and VLD is updated to “1”. Moreover, at STG2, STG3, and STG1 in MGTBL of FIG. 18B, Wh2d is updated to “15”, “15”, and “20”, respectively.

Next, in Step 10, on completion of writing of the write data (WDT[A1]), the storage module STG2 communicates the number of physical blocks in the erased state Esz (Esz2(139)) and the data size Wstg (Wstg2(30)) to the control circuit DKCTL0. Also, on completion of writing of the write data (WDT[A2]), the storage module STG3 communicates the number of physical blocks in the erased state Esz (Esz3(119)) and the data size Wstg (Wstg3(40)) to the control circuit DKCTL0. Moreover, on completion of writing of the parity data (WDT[PA12]), the storage module STG1 communicates the number of physical blocks in the erased state Esz (Esz1(100)) and the data size Wstg (Wstg1(45)) to the control circuit DKCTL0 (FIG. 18C).

After Step 10, the processing returns to Step 1b and the write control circuit WTCTL performs division of write data and generation parity data, targeting the next write data (WDT[B]) with a data size ntW B (here, 20). Here, the write data is divided into write data (WDT[B1]) with a data size ntW_B1 (here, 10) and write data (WDT[B2]) with a data size ntW_B2 (here, 10), and party data (PB12) with a data size ntW_PB12 (here, 10) is generated (FIG. 18C). Then, WTCTL generates respective write access requests (write command) including these write data and parity data. The information communicated in Step 10 is reflected on MGTBL in Step 2 (FIG. 180).

Now, the case where the storage module STG0, having received the garbage collection request (GCrq) in Step 11, as described above, completes the garbage collection operation, will be described. On completion of the garbage collection operation, the storage module STG0 transmits the number of physical blocks in the erased state Esz (Esz0(100)) and the data size Wstg (Wstg0(70)) after this garbage collection operation, to the control circuit DKCTL0 (FIG. 17, Step 12, and FIG. 18C).

In response to the completion of the garbage collection operation, the garbage collection control circuit GCCTL in the control circuit DKCTL0 updates the table GETBL. That is, as shown in FIG. 14A, the value of the garbage collection execution state GCv corresponding to the storage module number (STG No) of “0” becomes “0”, and this shows that the storage module STG0 is not executing the garbage collection operation. Also, the write control circuit WTCTL in the control circuit DKCTL0 sets the number of physical blocks in the erased state Esz (Esz0(100)) and the data size Wstg (Wstg0(70)) in the table MGTBL and thus updates MGTBL (FIG. 17, Step 2, and FIG. 18C).

Reading Method when RAID is Applied

FIG. 19 is an explanatory diagram showing an example of the read operation performed by the storage module control circuit of FIGS. 1 and 2 in the storage device system according to Embodiment 5 of the invention. In the example of FIG. 19, data A is composed of data A1 and A2. The data A1 is saved in the storage module STG2. The data A2 is saved in the storage module STG3. Also, parity data PA12 generated from the data A1 and A2 is saved in the storage module STG1.

Data B is composed of data B1 and B2. The data B1 is saved in the storage module STG1. The data B2 is saved in the storage module STG2. Also, parity data PB12 generated from the data B1 and B2 is saved in the storage module STG0. Data C is composed of data C1 and C2. The data C1 is saved in the storage module STG0. The data C2 is saved in the storage module STG1. Also, parity data PC12 generated from the data C1 and C2 is saved in the storage module STG3. Data D is composed of data D1 and D2. The data D1 is saved in the storage module STG2. The data D2 is saved in the storage module STG3. Also, parity data PD12 generated from the data D1 and D2 is saved in the storage module STG0.

Here, for example, the case where a garbage collection request (GCrq) is issued to the storage module STG1 from the garbage collection control circuit GCCTL in the control circuit DKCTL0 and where, in response to this, the read control circuit RDCTL performs the read operation of the data B while STG1 is executing the garbage collection operation, is considered as an example. In this case, RDCTL can grasp that the storage module STG1 is executing the garbage collection operation, on the basis of the table GETBL as described with reference to FIG. 14. Also, RDCTL can grasp that the data B1 and B2 are saved in the storage modules STG1 and STG2 and that the parity data PB12 is saved in the storage module STG0, on the basis of the table STGTBL as described with reference to FIG. 5 and from the logical addresses LAD corresponding to the respective data.

Therefore, the read control circuit RDCTL reads out the data B2 saved in the storage module STG2 and the parity data PB12 saved in the storage module STG0, which are not the storage module STG1 currently executing the garbage collection operation. Next, RDCTL restores the data B, using the data B2 and the parity data PB12 (restores the data B1 and then restores the data B based on the B1 and B2). In this way, as the RAID function is realized by the storage controller STRGCONT (control circuit DKCTL), data can be read out without waiting for the completion of the garbage collection operation, and improved reliability and a higher speed of the operation of the storage system can be realized.

As described above, by using the storage device system of this Embodiment 5, typically, it is possible to realize the leveling of the number of erasures (and consequently the leveling of the number of writes) in the storage device system as a whole, and to realize improved reliability and a longer life or the like, as in the cases of Embodiments 1 and 3. Also, since the storage controller STRGCONT manages the garbage collection operation, it is possible to grasp which storage module is executing the garbage collection operation and which storage module is capable of writing and reading, and therefore to execute the garbage collection operation and the write and read operation simultaneously. Consequently, a higher speed or the like of the storage system can be achieved while the leveling is performed. In addition, as the storage controller STRGCONT (control circuit DKCTL) realizes the RAID function, further improvement in reliability can be realized.

### Embodiment 6

In this Embodiment 6, a modification of the storage module (memory module) STG shown in FIG. 6 of Embodiment 1 will be described.

### Configuration of Storage Module (Memory Module) (Modification)

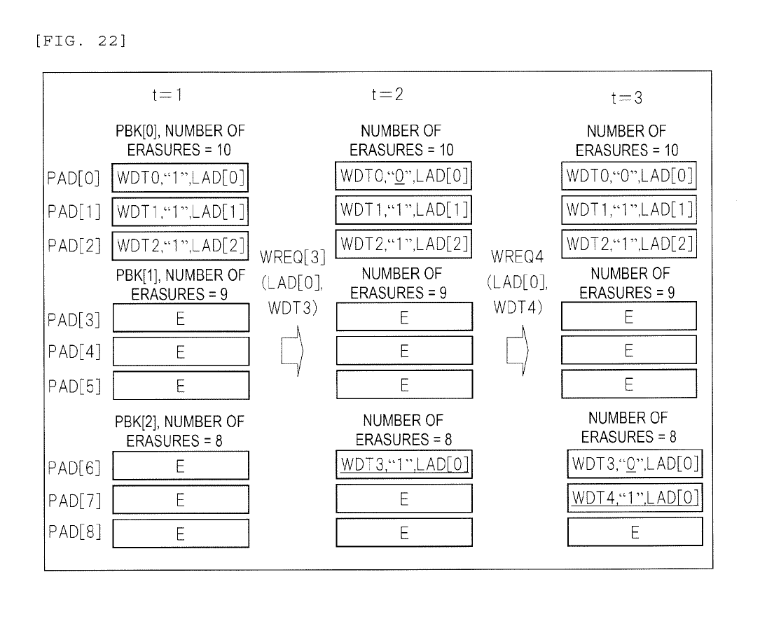

FIG. 21 is a block diagram showing a detailed configuration example of the storage module of FIG. 1 in the storage device system according to Embodiment 6 of the invention. Compared with the configuration example of FIG. 6, the storage module (memory module) STG shown in FIG. 21 is different in that random access memory RAMst of FIG. 6 is replaced by a non-volatile memory NVMEMst, instead of deleting the battery backup unit BBU of FIG. 6. Other parts of the configuration are similar to the case of FIG. 6 and therefore detailed explanation thereof is omitted.

As the non-volatile memory NVMEMst, a memory in which a higher-speed write operation than in a NAND-type flash memory is possible and to which access on a smaller unit basis (for example on a byte basis or the like) is possible, is used. Typically, a phase-change memory (PCM: Phase Change Memory), SPRAM (Spin transfer torque RAM), MRAM (Magnetoresistive RAM), FRAM (Ferroelectric RAM) (registered trademark), resistance-change memory (ReRAM: Resistive RAM) or the like can be employed. By using such an NVMEMst, it is possible to quickly update a table or the like held in the NVMEMst and also to hold information in a table or the like that is immediately before a sudden power cutoff or the like, even when that happens.

### Summary of Typical Effects of these Embodiments

Typical effects achieved by the above-described embodiments are summarized as follows.

Firstly, as the plurality of storage modules (memory modules) communicates to the storage controller the write data volume with which writing is actually performed to the non-volatile memories, the storage controller can find the predicted write data volume of each storage module, from the write data volume to be written next. Then, the storage controller can write the next data in the storage module having the smallest predicted write data volume. Thus, leveling of the number of writes among the plurality of storage modules in the storage system (storage device system) can be performed highly efficiently, and a storage system with high reliability and a long life can be realized.

Secondly, as the plurality of storage modules communicates the life to the storage controller in addition to the write data volume with which writing is actually performed to the non-volatile memories, the storage controller can find the above-mentioned predicted write data volume, targeting a storage module having a life equal to or longer than the remaining life of the storage system. Then, the storage controller can write the next data in the storage module with the smallest predicted write data volume, from among the target storage modules. Thus, while the product life of the storage system is protected, leveling of the number of writes among the plurality of storage modules can be performed highly efficiently, and a storage system with high reliability and a long life can be realized.

The invention made by the present inventor is specifically described above on the basis of the embodiments. However, invention is not limited to the embodiments, and various changes can be made without departing from the scope of the invention. For example, the above-described embodiments are described in detail in order to explain the invention intelligibly, and not necessarily limited to embodiments including all the described configurations. Also, it is possible to replace a part of the configuration of one embodiment with the configuration of another embodiment, or to add the configuration of one embodiment to the configuration of another embodiment. Moreover, it is possible to make an addition, deletion, or replacement with another configuration, with respect to apart of the configuration of each embodiment.

### REFERENCE SIGNS LIST

ARB arbiter circuit
BBU battery backup unit
BIF interface circuit
BP back plane
BUF buffer
CM cache memory
CMCTL cache control circuit
CPU processor unit
CPUCR processor core
DIAG diagnostic circuit
DKCTL control circuit
ERSCTL data erasure control circuit
ERSv erasure execution state
Est erasure status
Esz number of physical blocks in erased state
GCCTL garbage collection control circuit
GCv garbage collection execution state
Gst garbage collection status
H2D_IF interface signal
H2S_IF interface signal
HCTL control circuit
HDIAG diagnostic circuit
HOST_IF interface circuit
HRDCTL read control circuit
HWTCTL write control circuit
LAD logical address
MGTBL, STGTBL, GETBL table
MNGER information processing circuit
NVM non-volatile memory
NVMEMst non-volatile memory
PAD physical address
PBK physical block
RAM, RAMst random access memory
RAMC, NVCT0 to NVCT7 memory control circuit
RDCTL read control circuit
Ret data retention time (remaining life)
RetTBL table
SIFC interface circuit
SRV information processing device (host)
STCT control circuit
STG storage module (memory module)
STIF interface circuit
STRGCONT storage controller
STRGSYS storage system (storage device system)
VLD validity information
WAF write data size ratio
WDT write data
WTCTL write control circuit
Wstg, Wh2d, ntW data size
dLife life information (threshold of remaining life)
eWd predicted write data size

1. A storage device system comprising:
a plurality of memory modules; and
a first control circuit for controlling the plurality of memory modules;
wherein each memory module of the plurality of memory modules has a plurality of non-volatile memories and a second control circuit for controlling the non-volatile memories,
the second control circuit grasps a second write data volume with which writing is actually performed to the plurality of non-volatile memories, and notifies the first control circuit of the second write data volume, and
the first control circuit grasps a first write data volume involved in a write command that is already issued to the plurality of memory modules, for each memory module of the plurality of memory modules, then calculates a first ratio that is a ratio of the first write data volume to the second write data volume, for each memory module of the plurality of memory modules, and selects a memory module to which a next write command is to be issued, from among the plurality of memory modules, reflecting a result of the calculation.

2. The storage device system according to claim 1, wherein
the first control circuit calculates a fourth writ data volume that is a result of addition of a data volume obtained by multiplying a third write data volume involved in the next write command by the first ratio, and the second write data volume, for each memory module of the plurality of memory modules, and selects a memory module to which the next write command is to be issued, from among the plurality of memory modules, on the basis of the result of the calculation.

3. The storage device system according to claim 2, wherein
the first control circuit selects a memory module having the smallest data volume of the fourth write data volumes calculated for each memory module of the plurality of memory modules, and issues the next write command to the selected memory module.

4. The storage device system according to claim 1, wherein
the second control circuit further holds a dependence relation between a number of erasures or number of writes and a remaining life of the plurality of non-volatile memories, and communicates the remaining life obtained on the basis of the dependence relation, to the first control circuit, and
the first control circuit further decides an issue destination candidate of the next write command from among the plurality of memory modules, reflecting the remaining life of each memory module of the plurality of memory modules communicated from the second control circuit, and selects a memory module to which the next write command is to be issued, from among the candidates, reflecting the result of the calculation of the first ratio.

5. The storage device system according to claim 4, wherein
the first control circuit holds a first threshold of the remaining life, and decides a single or a plurality of memory modules having the remaining life that is equal to or longer than the first threshold, as an issue destination candidate of the next write command.

6. The storage device system according to claim 5, wherein
the first control circuit performs variable control of the first threshold.

7. The storage device system according to claim 6, wherein
the first control circuit calculates a fourth writ data volume that is a result of addition of a data volume obtained by multiplying a third write data volume involved in the next write command by the first ratio, and the second write data volume, for each memory module of the plurality of memory modules, and selects a memory module to which the next write command is to be issued, from among the plurality of memory modules, on the basis of the result of the calculation.

8. The storage device system according to claim 7, wherein
the first control circuit selects a memory module having the smallest data volume of the fourth write data volumes calculated for each memory module of the plurality of memory modules, and issues the next write command to the selected memory module.

9. The storage device system according to claim 1, wherein
the second control circuit executes wear leveling and garbage collection, targeting the plurality of non-volatile memories.

10. The storage device system according to claim 9, wherein
the second control circuit further communicates a number of physical blocks in an erased state included in the plurality of non-volatile memories, to the first control circuit, and
the first control circuit further holds a second threshold of the number of physical blocks in the erased state, then issues an execution command for the garbage collection to a memory module in which the number of physical blocks in the erased state is equal to or below the second threshold and thereby grasps a memory module that is executing the garbage collection, and selects a memory module from among other memory modules than the memory module that is executing the garbage collection, when selecting a memory module to which the next write command is to be issued.

11. The storage device system according to claim 9, wherein
the second control circuit communicates the second write data volume to the first control circuit every time actual writing in the plurality of non-volatile memories performed in response to the write command from the first control circuit is completed.

12. The storage device system according to claim 9, wherein
the second control circuit communicates the second write data volume to the first control circuit every time the wear leveling performed targeting the plurality of non-volatile memories is completed.

13. The storage device system according to claim 9, wherein
the second control circuit communicates the second write data volume to the first control circuit every time the garbage collection performed targeting the plurality of non-volatile memories is completed.

14. A storage device system comprising:
a plurality of memory modules; and
a first control circuit which has a first table, receives a first write command from a host, selects a write destination of data involved in the first write command from among the plurality of memory modules on the basis of the first table, and issues a second write command to the selected memory module;
wherein each memory module of the plurality of memory modules has a plurality of non-volatile memories and a second control circuit which controls the plurality of non-volatile memories,
the second control circuit performs writing involved in the second write command and writing involved in wear leveling or garbage collection, to the plurality of non-volatile memories, then grasps a second write data volume generated by the writing involved in the second write command and the writing involved in the wear leveling or the garbage collection, and communicates the second write data volume to the first control circuit,
in the first table, the second write data volume, and a first write data volume involved in the second write command that is already issued, are held for each memory module of the plurality of memory modules, and
the first control circuit calculates a first ratio that is a ratio of the first write data volume to the second write data volume for each memory module of the plurality of memory modules on the basis of the first table, and selects a memory module to which the second write command that comes next is to be issued, from among the plurality of memory modules, reflecting the result of the calculation.

15. The storage device system according to claim 14, wherein
the second control circuit further holds a dependence relation between a number of erasures or number of writes and a remaining life of the plurality of non-volatile memories, and communicates the remaining life obtained on the basis of the dependence relation, to the first control circuit,
in the first table, the remaining life is held for each memory module of the plurality of memory modules, and
the first control circuit further decides an issue destination candidate of the second write command that comes next, from among the plurality of memory modules, reflecting the remaining life in the first table, and selects a memory module to which the second write command that comes next is to be issued, from among the candidates, reflecting the result of the calculation of the first ratio.
